(19) United States
(12) Patent Application Publication
(10) Pub. No.: US 2026/0054922 A1
(43) Pub. Date: Feb. 26, 2026

(54) SYSTEMS AND METHODS FOR IDENTIFYING REFUSE AND CONTROLLING COMPACTION SYSTEM FOR REFUSE VEHICLE

(71) Applicant: Oshkosh Corporation, Oshkosh, WI (US)

(72) Inventors: Vince Schad, Oshkosh, WI (US); Andy Cornelius, Oshkosh, WI (US); Nick Weykamp, Oshkosh, WI (US); Quincy Wittman, Oshkosh, WI (US); Jerrod Kappers, Oshkosh, WI (US); Brendan Chan, Oshkosh, WI (US); Eric Olson, Oshkosh, WI (US); Zhenyi Wei, Oshkosh, WI (US); Alec Ehlke, Oshkosh, WI (US); Jeff Meyer, Oshkosh, WI (US); Umang Patel, Oshkosh, WI (US); Austin Mahoney, Oshkosh, WI (US); Thomas Vale, Oshkosh, WI (US); William Young, Oshkosh, WI (US); Johnny Bui, Oshkosh, WI (US); Nagabhushana Sharma Gurumurthy, Oshkosh, WI (US); Jacob Wallin, Oshkosh, WI (US); Derek Wente, Oshkosh, WI (US)

(73) Assignee: Oshkosh Corporation, Oshkosh, WI (US)

(21) Appl. No.: 19/306,803

(22) Filed: Aug. 21, 2025

Related U.S. Application Data
(60) Provisional application No. 63/686,096, filed on Aug. 22, 2024.

(51) Int. Cl. B65F 3/14; B60K 35/28; B60K 35/81

(52) U.S. Cl. CPC B65F 3/143; B60K 35/28; B60K 35/81; B65F 2003/146

(57) ABSTRACT

A refuse vehicle includes a chassis, a body coupled to the chassis, a camera, and one or more processing circuits. The body defines a refuse compartment configured to store refuse therein. The one or more processing circuits are configured to acquire, from the camera, image data corresponding to refuse acquired by the refuse vehicle, determine, based on the image data, at least one parameter corresponding to at least one object within the refuse, generate, based on the image data and the at least one object within the refuse, display data including the image data and at least one display element identifying the at least one object within the refuse, and provide the display data to a user interface of the refuse vehicle.

### CROSS-REFERENCE TO RELATED APPLICATIONS

This application claims the benefit of and priority to U.S. Provisional Application No. 63/686,096 filed Aug. 22, 2024, the entire contents of which are hereby incorporated by reference herein.

### BACKGROUND

The present disclosure generally relates to the field of refuse vehicles. More specifically, the present disclosure relates to control systems for refuse vehicles.

### SUMMARY

One exemplary embodiment of the present disclosure relates to a refuse vehicle. The refuse vehicle includes a chassis, a body coupled to the chassis, a camera, and one or more processing circuits. The body defines a refuse compartment configured to receive refuse therein. In some embodiments, the camera is oriented toward the refuse compartment. The one or more processing circuits are configured to acquire, from the camera, image data corresponding to refuse acquired by the refuse vehicle, determine, based on the image data, at least one parameter corresponding to at least one object within the refuse, generate, based on the image data and the at least one object within the refuse, display data including the image data and at least one display element identifying the at least one object within the refuse, and provide the display data to a user interface of the refuse vehicle.

Another exemplary embodiment of the present disclosure relates to a method for operating a refuse vehicle. The method includes acquiring, from a camera onboard the refuse vehicle, image data corresponding to refuse acquired by the refuse vehicle, determining, based on the image data, at least one parameter corresponding to at least one object within the refuse, generating, based on the image data and the at least one parameter, display data including the image data and at least one display element identifying the at least one object within the refuse, and providing the display data to a user interface of the refuse vehicle.

Yet another exemplary embodiment of the present disclosure relates to a control system for a refuse vehicle. The control system includes a camera and one or more processing circuits configured to be communicably coupled to the camera. The refuse vehicle includes a chassis and a body coupled to the chassis. The body defines a refuse compartment configured to store refuse therein. The one or more processing circuits are configured to acquire, from the camera, image data corresponding to refuse acquired by the refuse vehicle, determine, based on the image data, at least one parameter corresponding to at least one object within the refuse, wherein the at least one parameter includes a non-compliant parameter corresponding to a contaminant within the refuse, generate, based on the image data and the at least one object within the refuse, display data including the image data and at least one display element identifying the at least one object within the refuse, and provide the display data to a user interface of the refuse vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for any of the refuse vehicles of FIGS. 1-3, according to an exemplary embodiment;

FIG. 5 is a diagram illustrating a collection route for autonomous transport and collection by any of the refuse vehicles of FIGS. 1-3, according to an exemplary embodiment;

FIG. 6 is a top perspective view of a side-loading refuse vehicle, according to an exemplary embodiment;

FIG. 7 is a rear perspective view of a rear-loading refuse vehicle, according to an exemplary embodiment;

FIG. 8 is a top perspective view of a refuse compartment of the side-loading refuse vehicle of FIG. 6, according to an exemplary embodiment;

FIG. 9 is a side view of a refuse compartment of the rear-loading refuse vehicle of FIG. 7, according to an exemplary embodiment;

FIG. 10 is a section view of the refuse compartment of FIG. 9 with a tailgate compaction assembly configured as a slide, according to an exemplary embodiment;

FIG. 11 is a section view of the refuse compartment of FIG. 9 with a tailgate compaction assembly configured as a sweep with a linear actuator, according to an exemplary embodiment;

FIG. 12 is a section view of the refuse compartment of FIG. 9 with a tailgate compaction assembly configured as a sweep with a rotational actuator, according to an exemplary embodiment;

FIG. 13 is a section view of the refuse compartment of FIG. 8 with a packer system in a retracted configuration, according to an exemplary embodiment;

FIG. 14 is a section view of the refuse compartment of FIG. 8 with a packer system in a partially extended configuration, according to an exemplary embodiment;

FIG. 15 is a section view of the refuse compartment of FIG. 8 with a packer system in an extended configuration, according to an exemplary embodiment;

FIG. 16 is a section view of the refuse compartment of FIG. 8 with a packer system in a retracted configuration, according to an exemplary embodiment;

FIG. 17 is a section view of the refuse compartment of FIG. 8 with a packer system in a partially extended configuration, according to an exemplary embodiment;

FIG. 18 is a section view of the refuse compartment of FIG. 8 with a packer system in an extended configuration, according to an exemplary embodiment;

FIG. 19 is a perspective view of the refuse compartment of FIG. 8 with an object recognition system, according to an exemplary embodiment;

FIG. 20 is a perspective view of the refuse compartment of FIG. 8 with an object recognition system, according to an exemplary embodiment;

FIG. 21 is a perspective view of the refuse compartment of FIG. 8 with an object recognition system, according to an exemplary embodiment;

FIG. 22 is a perspective view of the refuse compartment of FIG. 9 with an object recognition system, according to an exemplary embodiment;

FIG. 23 is a block diagram of a control system for any of the refuse vehicles of FIGS. 1-3, according to an exemplary embodiment;

FIG. 24 is a block diagram of a controller of the control system of FIG. 23, according to an exemplary embodiment;

FIG. 25 is an example image generated by the controller of FIG. 24, according to example embodiments;

FIG. 26 is another example image generated by the controller of FIG. 24, according to example embodiments;

FIG. 27 is another example image generated by the controller of FIG. 24, according to example embodiments;

FIG. 28 is an illustration of a configuration of a user interface generated by the controller of FIG. 24, according to example embodiments;

FIG. 29 is an illustration of a configuration of a user interface generated by the controller of FIG. 24, according to example embodiments;

FIG. 30 is a block diagram of a communication system, according to example embodiments;

FIG. 31 is a flow chart of a process for determining a pack profile for a compaction system of a refuse vehicle using image data, according to example embodiments; and

FIG. 32 is a flow chart of a process for identifying non-compliant parameters associated with image data from a camera of a refuse vehicle, according to example embodiments.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, a refuse vehicle includes an object recognition system configured to determine a type of an object associated with the refuse vehicle using sensors. For example, a camera may be positioned such that a field of view of the camera is positioned to include a hopper volume of a refuse compartment of the refuse vehicle. Processing circuitry of the refuse vehicle may obtain image data from the camera that can be analyzed to determine a type of the refuse contained within the hopper volume. The processing circuitry may then determine a packing profile associated with the type of the refuse that includes operational parameters for the type of the refuse for a compaction system of the refuse vehicle. The compaction system may be configured to compact refuse within a storage volume of the refuse vehicle to reduce a volume of the refuse stored within the storage volume. The operational parameters for the packing profiles may be preselected to optimize the operation of the compaction system with regards to the type of the refuse. The processing circuitry may operate the compaction system of the refuse vehicle according to the packing profile or may generate an alert to notify an operator of the refuse vehicle that the refuse vehicle is not operating according to the packing profile.

### Refuse Vehicle

### Front-Loading Configuration

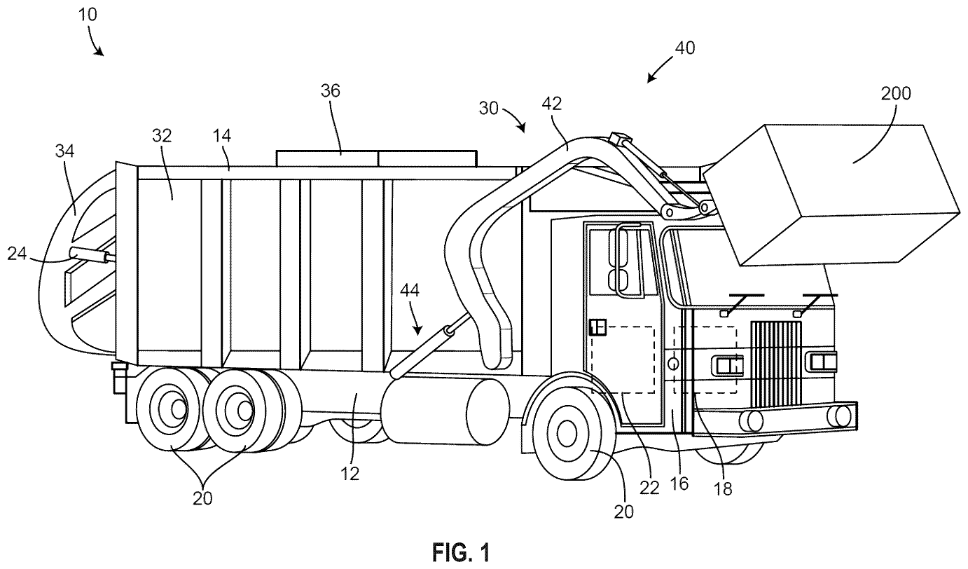

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment as described in greater detail in U.S. application Ser. No. 17/558,183, filed Dec. 12, 2021, the entire disclosure of which is incorporated by reference herein.

### Rear-Loading Configuration

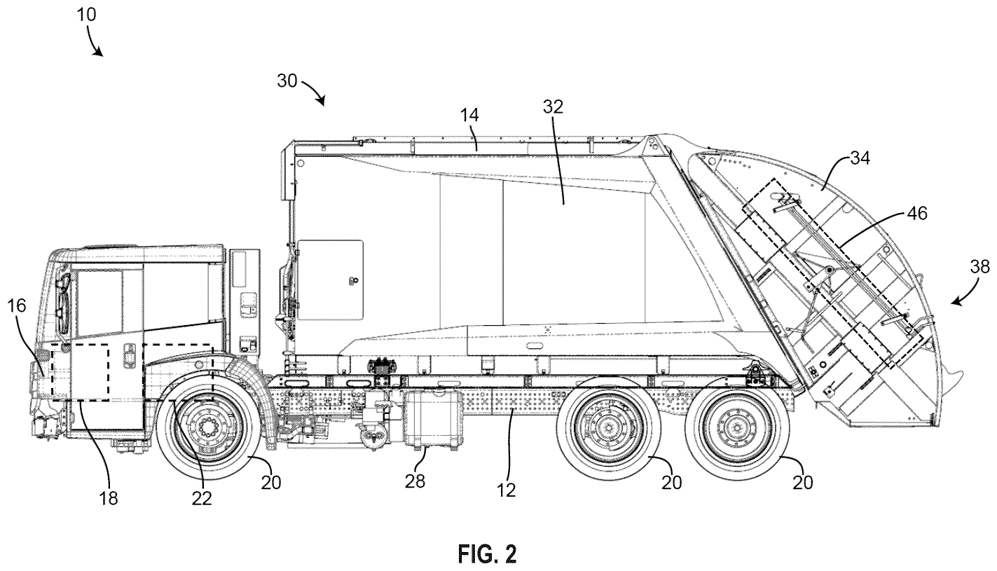

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

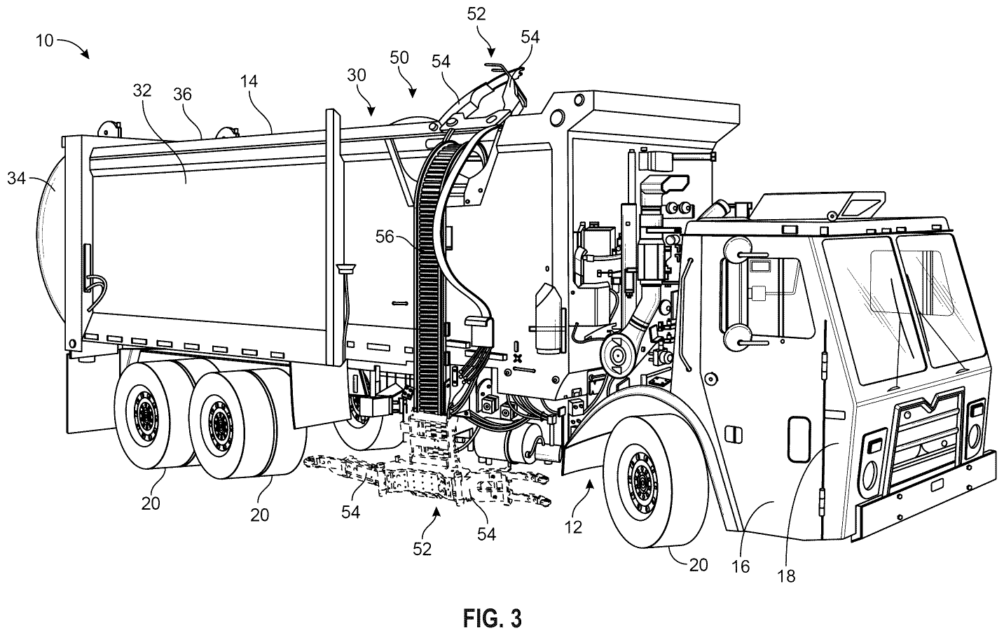

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

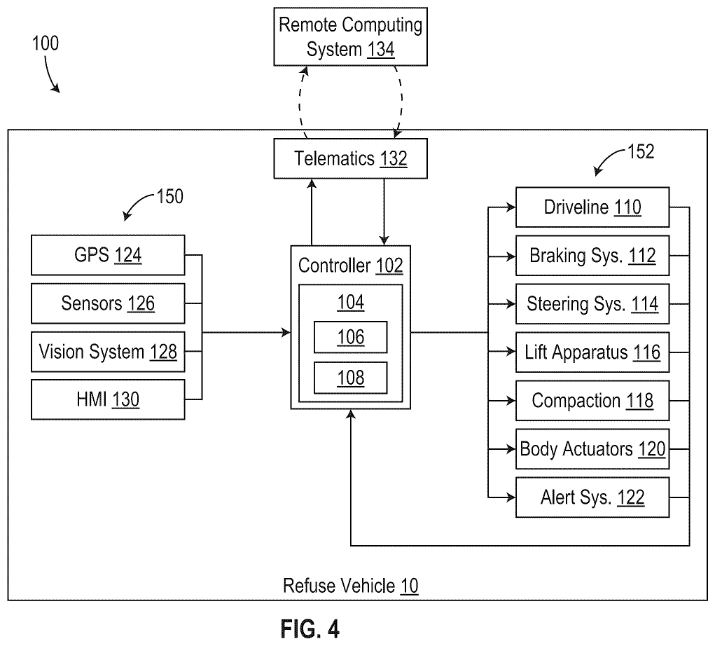

Referring to FIG. 4, the refuse vehicle 10 may include a control system 100 that is configured to facilitate autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may be configured to operate actuators or motors of the lift apparatus 116 (e.g., lift arm actuators 44) to perform a lifting operation (e.g., to grasp, lift, empty, and return a refuse container). The controller 102 may be configured to operate the compaction system 118 to compact or pack refuse that is within the refuse compartment 30. The controller 102 may be configured to operate the body actuators 120 to implement a dumping operation of refuse from the refuse compartment 30 (e.g., driving the refuse compartment 30 to rotate to dump refuse at a landfill). The controller 102 may be configured to operate the alert system 122 (e.g., lights, speakers, display screens, etc.) to provide one or more aural or visual alerts to nearby individuals.

The controller 102 may be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS system 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may operate or implement geofences as described in greater detail in U.S. application Ser. No. 17/232,855, filed Apr. 16, 2021, the entire disclosure of which is incorporated by reference herein.

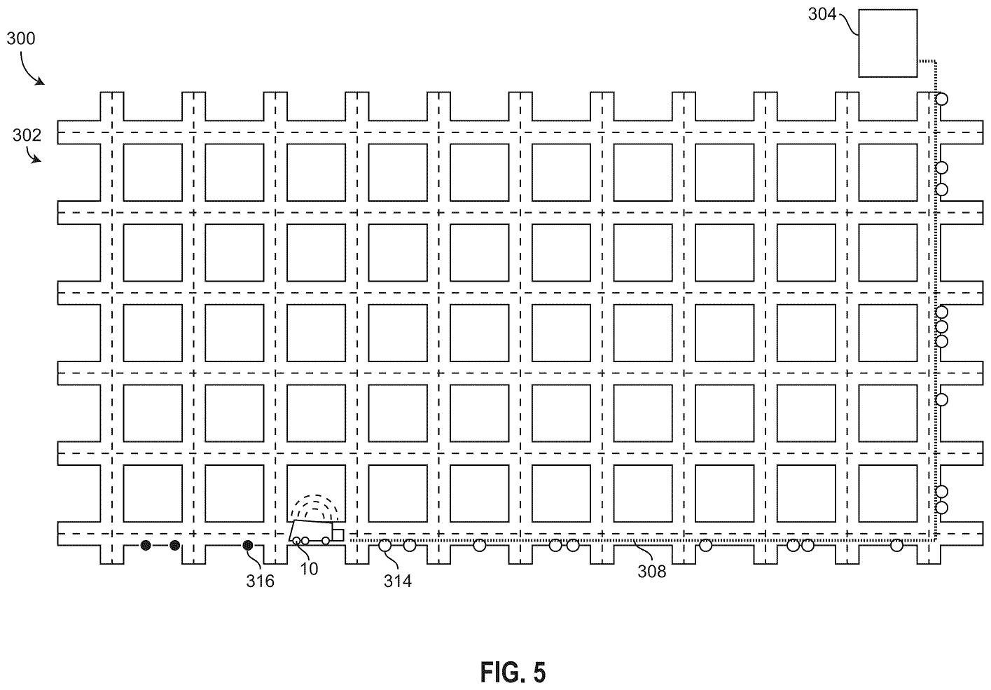

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

### Refuse Compartment

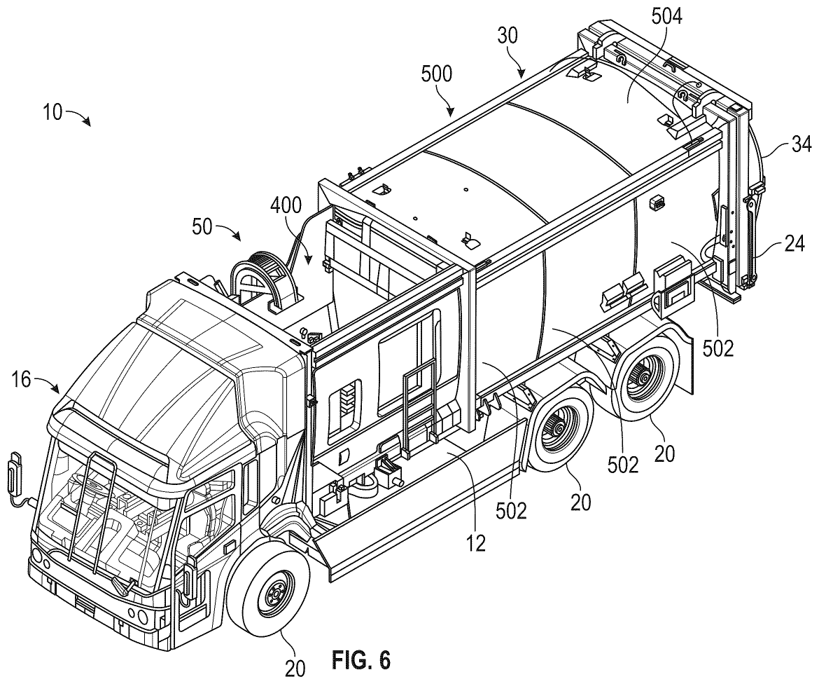

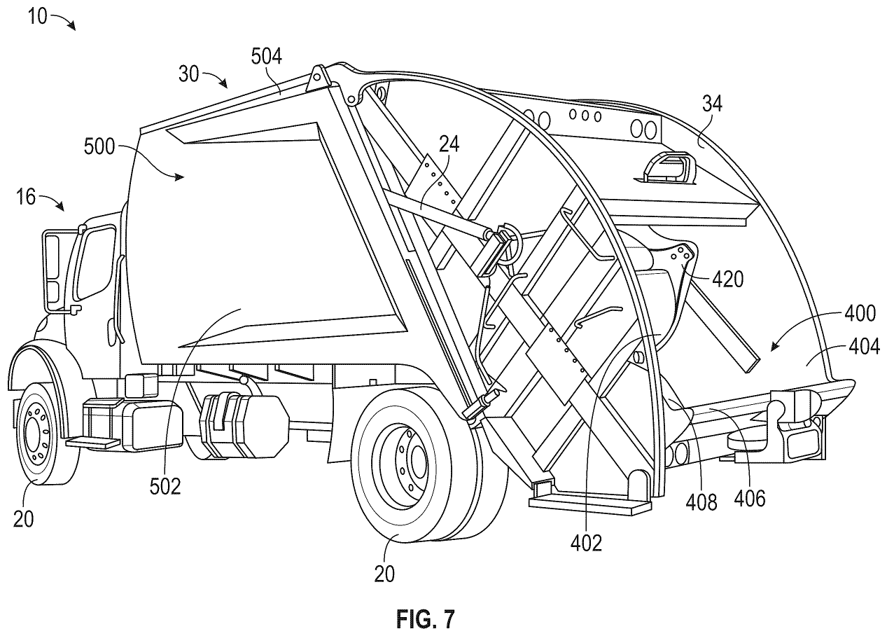

Referring to FIGS. 6 and 7, the refuse compartment 30 defines a hopper volume 400 and a storage volume 500. In this regard, refuse may be initially loaded into the hopper volume 400 and later compacted into the storage volume 500. According to the exemplary embodiment shown in FIG. 5, the hopper volume 400 is positioned between the storage volume 500 and the cab 16 (e.g., refuse is loaded into a portion of the refuse compartment 30 behind the cab 16 and stored in a portion further toward the rear of the refuse compartment 30, in a front loading refuse vehicle, in a side loading refuse vehicle, etc.). According to the exemplary embodiment shown in FIG. 6, the storage volume 500 is positioned between the hopper volume 400 and the cab 16 (e.g., in a rear-loading refuse truck, etc.).

FIG. 7 illustrates an exemplary embodiment of the refuse compartment 30 of the refuse vehicle 10. As shown in FIG. 7, the hopper volume 400 is an internal volume positioned in the tailgate 34 and is defined by a left sidewall 402, a right sidewall 404, a hopper floor 406, a holding plate 408, and a tailgate compaction assembly 420. The left sidewall 402 and the right sidewall 404 extend between the hopper floor 406 and the holding plate 408. In general, the hopper floor 406 is configured to support refuse contained in the hopper volume 400 prior to the refuse being transferred to the storage volume 500. In some embodiments, the hopper floor 406 may be configured in a bowl shape to receive and store refuse. The holding plate 408 extends at a downward angle (e.g., in a direction partially perpendicular to the ground on which the refuse vehicle 10 travels, etc.) from the storage volume 500 to the hopper floor 406. In general, the holding plate 408 separates the hopper volume 400 and the storage volume 500 and forms a partition between the two sections in the refuse compartment 30. In some embodiments, the holding plate 408 may define a hopper aperture configured to selectively allow refuse to transfer from the hopper volume 400 to the storage volume 500. In addition, the holding plate 408 aids in preventing refuse being packed into the storage volume 500 from falling back toward the hopper volume 400. The tailgate compaction assembly 420 is part of the compaction system 118 and is configured to transfer refuse from the hopper volume 400 to the storage volume 500. In some embodiments, the tailgate compaction assembly 420 compacts refuse into the storage volume 500 (e.g., compresses the refuse, the tailgate compaction assembly 420 is the packer 46, etc.). In other embodiments, the tailgate compaction assembly 420 transfers the refuse from the hopper volume 400 to the storage volume 500 and the packer 46 separately compacts the refuse in the storage volume 500.

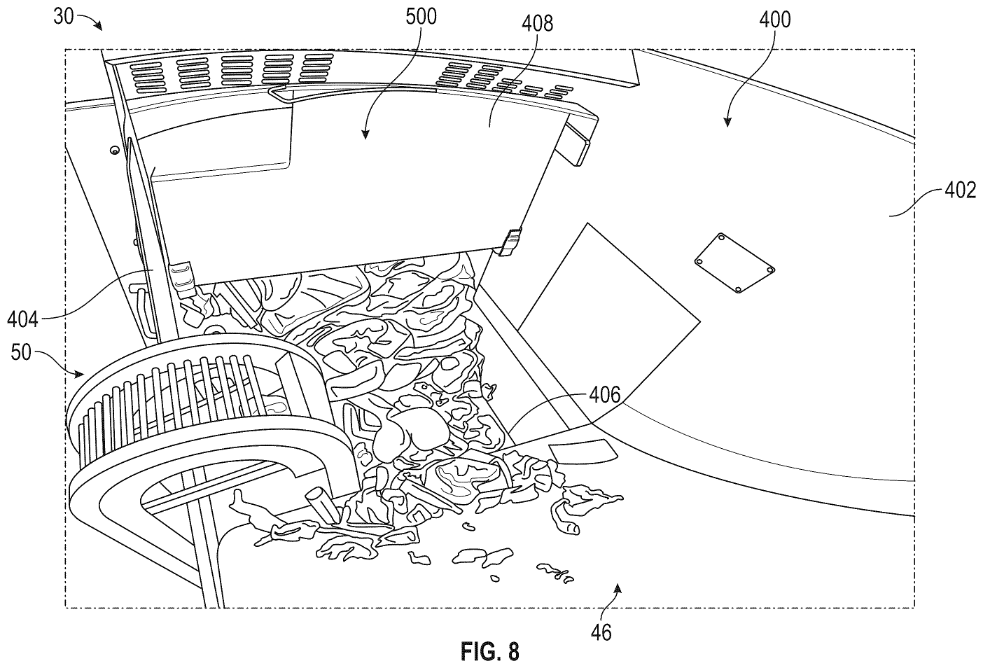

FIG. 8 illustrates an exemplary embodiment of the refuse compartment 30 of the refuse vehicle 10. As shown in FIG. 8, the hopper volume 400 is an internal volume of the refuse compartment 30 and is defined by the left sidewall 402, the right sidewall 404, the hopper floor 406, the holding plate 408, and the packer 46. The left sidewall 402 extends longitudinally (e.g., in a direction extending between the cab 16 and the tailgate 34) between the holding plate 408 and the packer 46. The lift assembly 50 is arranged on the right sidewall 404. The hopper floor 406 extends horizontally (e.g., in a direction parallel to the ground on which the refuse vehicle 10 travels, etc.). between the left sidewall 402 and the right sidewall 404. In general, the hopper floor 406 is configured to support refuse contained in the hopper volume 400 prior to the refuse being transferred to the storage volume. The holding plate 408 extends downwardly (e.g., in a direction toward the frame 12, or in a direction perpendicular to the ground on which the refuse vehicle 10 travels) from a top wall of the refuse compartment 30. In general, the holding plate 408 separates the hopper volume 400 and the storage volume 500 and forms a partition between the two sections in the refuse compartment 30. In addition, the holding plate 408 aids in preventing refuse being packed into the storage volume 500 from falling back toward the hopper volume 400.

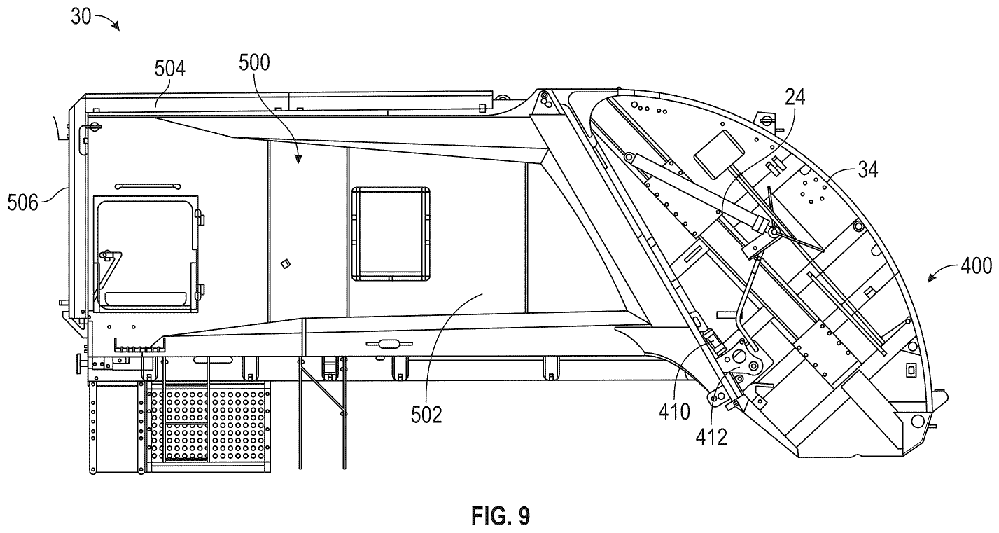

Referring to FIGS. 6 and 7, the storage volume 500 is an internal volume positioned in the refuse compartment 30 and is defined by panels 502 (e.g., the panels 32, etc.), a cover 504 (e.g., the cover 36, etc.), and the tailgate 34. According to the exemplar embodiment shown in FIG. 8, the storage volume 500 is further defined by the holding plate 408. According to the exemplary embodiment shown in FIG. 9, the storage volume 500 is further defined by a front panel 506.

According to the exemplary embodiment shown in FIG. 9, the tailgate 34 further includes a lock actuator 410. In some embodiments, the lock actuator 410 may be configured to rotate a locking flange 412 to lock the tailgate 34 in the closed position. In some embodiments, the lock actuator 410 is an electrically-driven linear actuator. For example, in some embodiments, the lock actuator 410 is one of a lead screw/lead nut type actuator, a lead screw/ball nut type actuator, a lead screw/roller nut type actuator, a linear motor, or any other suitable type of electrically-driven linear actuator.

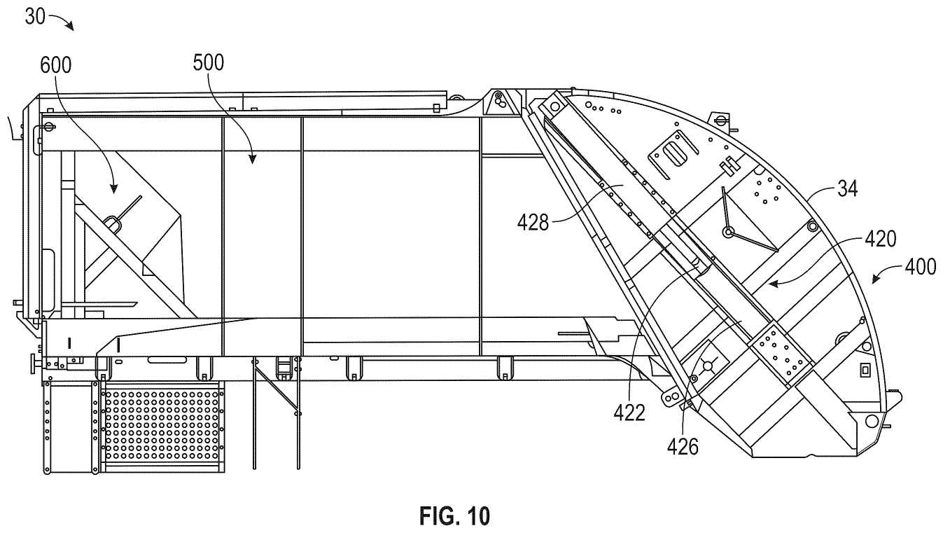

According to the exemplary embodiment shown in FIGS. 10-12, the tailgate compaction assembly 420 includes a carriage, shown as a slide 422, a compactor element, shown as a blade or a sweep 424, a track 426, a carriage actuator 428, and a compactor actuator (e.g., a linear compactor actuator 430 and/or a rotational compactor actuator 432). The slide 422 is coupled to and configured to move the sweep 424, along a track 426 to aid in the loading and/or packing of refuse into the storage volume 500. Specifically, the slide 422 is configured to move the sweep 424 along the track 426 between an extended position and a retracted or packing position using a carriage actuator 428. In some embodiments, the carriage actuator 428 is an electrically-driven linear actuator. For example, in some embodiments, the carriage actuator 428 is one of a lead screw/lead nut type actuator, a lead screw/ball nut type actuator, a lead screw/roller nut type actuator, a linear motor, or any other suitable type of electrically-driven linear actuator.

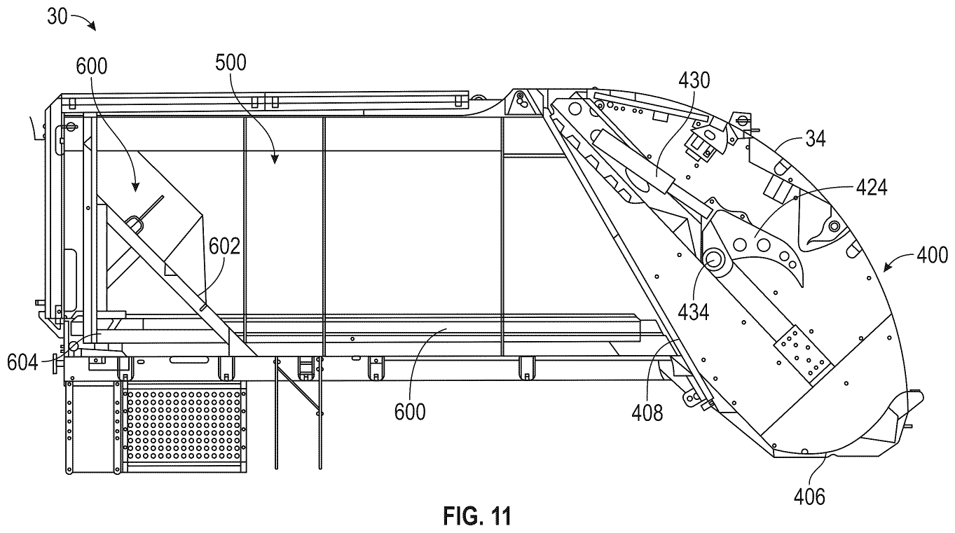

As shown in FIG. 11, the sweep 424 is rotatably coupled to the slide 422 at a joint 434. The sweep 424 is rotatable about the joint 434 between a closed position and an opened or receiving position using a linear compactor actuator 430. In the closed position, the sweep 424 is rotated clockwise (with respect to the illustrative embodiment provided in FIG. 11) to angle the sweep 424 toward the storage volume 500, such that the sweep 424 is configured to selectively pack refuse into the storage volume 500 by moving the sweep 424 from the extending position into the retracted or packing position. In the opened or receiving position, the sweep 424 is rotated counter-clockwise (with respect to the illustrative embodiment provided in FIG. 11) to angle the sweep 424 out of the storage volume 500 to provide clearance for inserting refuse into or removing refuse from the storage volume 500. In some embodiments, the linear compactor actuator 430 is an electrically-driven linear actuator. For example, in some embodiments, the linear compactor actuator 430 is one of a lead screw/lead nut type actuator, a lead screw/ball nut type actuator, a lead screw/roller nut type actuator, a linear motor, or any other suitable type of electrically-driven linear actuator.

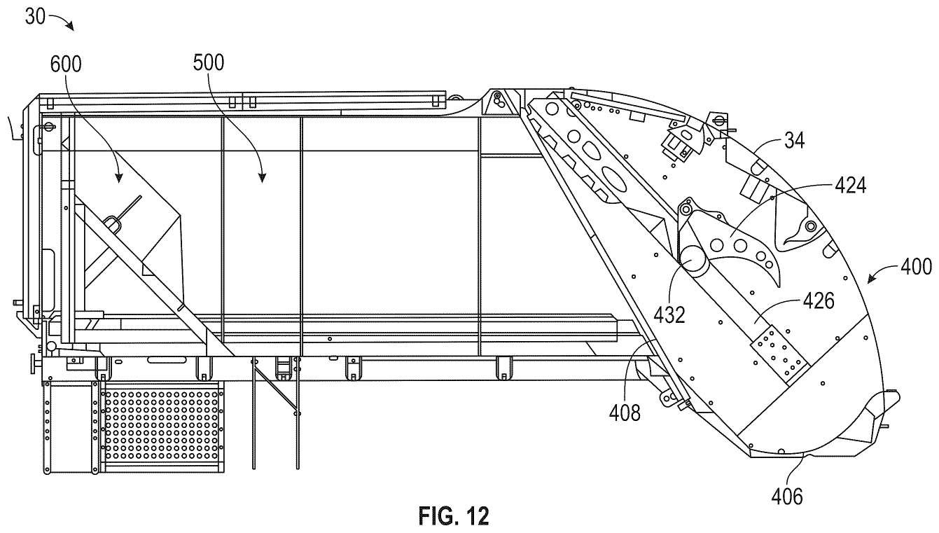

As shown in FIG. 12, in some embodiments, the sweep 424 is additionally or alternatively actuatable about the joint 434 by the rotational compactor actuator 432 (the joint 434 in FIG. 12 is disposed behind the rotational compactor actuator 432). The rotational compactor actuator 432 is rotationally engaged with the sweep 424 to move the sweep between the opened or receiving position and the closed position, as described above. In some embodiments, the rotational compactor actuator 432 is an electric motor configured to selectively rotate the sweep 424 a predetermined amount in either the clockwise or the counter-clockwise direction (with respect to the illustrative embodiment provided in FIG. 12).

As alluded to above, in some embodiments, the tailgate 34 may include only the linear compactor actuator 430. In other embodiments, the tailgate 34 may include only the rotational compactor actuator 432. In still other embodiments, the tailgate 34 may include both the linear compactor actuator 430 and the rotational compactor actuator 432 to provide additional closing force to the sweep 424, as necessary.

According to the exemplary embodiments shown in FIGS. 10-15, the refuse compartment 30 includes a packer system, shown as packer system 600. The packer system 600 is part of the compaction system 118 and is configured to pack (e.g., compress, etc.) refuse contained in the storage volume 500 to reduce the volume of the refuse (e.g., such that additional refuse may be stored in the storage volume 500, etc.). In some embodiments, the packer system 600 is configured to eject the refuse contained in the storage volume 500 (e.g., through the tailgate 34, etc.). For example, in a packing configuration, the tailgate 34 is in the closed position and the packer system 600 moves toward the tailgate 34, thereby compacting any refuse contained within the storage volume 500. In an ejecting configuration, the tailgate 34 is in the open position and the packer system 600 moves toward the tailgate 34, thereby ejecting any refuse contained within the storage volume 500. In some embodiments, the refuse compartment 30 includes both the tailgate compaction assembly 420 and the packer system 600 (e.g., the tailgate compaction assembly 420 transfers and compacts the refuse in the hopper volume 400 into the storage volume 500 and the packer system 600 compacts the refuse in the storage volume 500, etc.)

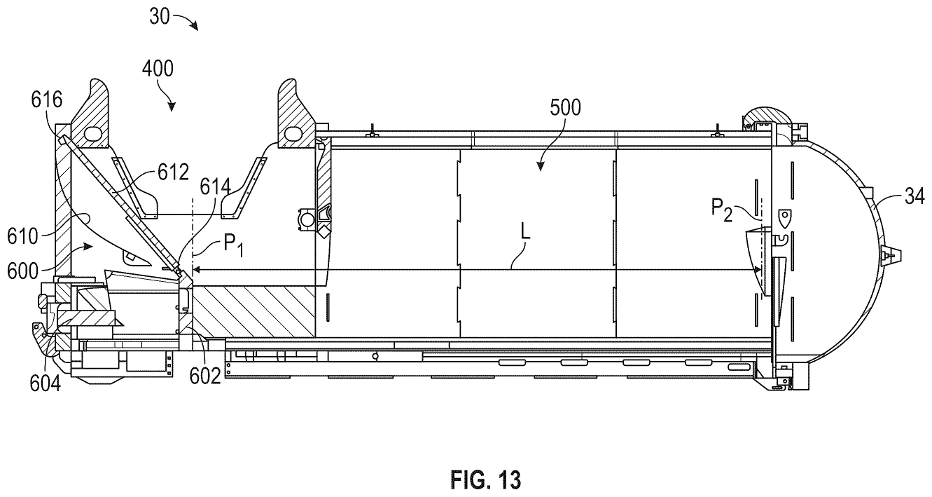

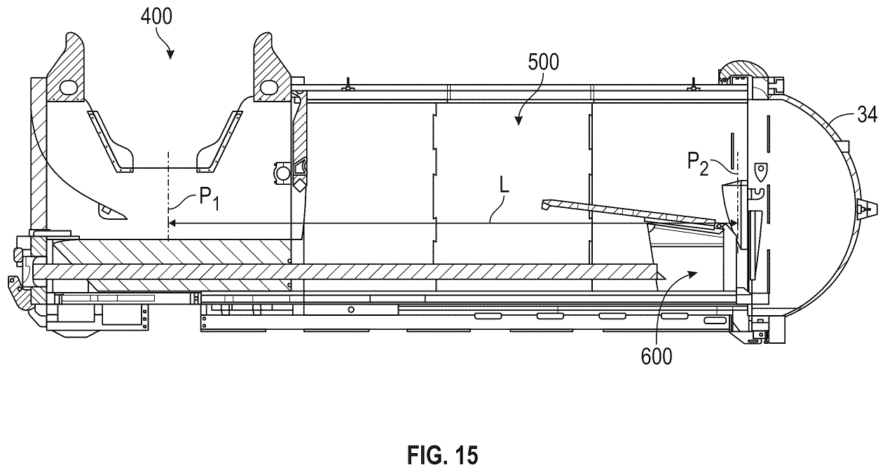

As shown in FIGS. 10-15, the packer system 600 includes a pack panel 602 and a packing actuator 604. The pack panel 602 faces in a direction toward the storage volume 500 (e.g., a normal extending from the outer surface of the pack panel 602 is directed toward the storage volume 500). The pack panel 602 is coupled to the packing actuator 604 so that the packing actuator 604 selectively moves the pack panel 602 between a retracted or home position (see, e.g., FIG. 13) and an extended or eject position (see, e.g., FIG. 15), between the extended position and the retracted position, and any position in between the extended position and the retracted position. In some embodiments, the packing actuator 604 is a telescoping actuator that is pneumatically, hydraulically, electronically, or electro-hydraulically driven. According to the exemplary embodiments shown in FIGS. 10-12, the pack panel 602 extends generally at an angle (e.g., in a direction at an angle to a road on which the vehicle 10 travels, etc.). According to the exemplary embodiments shown in FIGS. 13-15, the pack panel 602 extends generally vertically (e.g., in a direction perpendicular to a road on which the vehicle 10 travels).

According to the exemplary embodiment shown in FIGS. 10-12, the packer system 600 includes an ejector track 606. The pack panel 602 is slidably coupled to the ejector track 606 such that the packing actuator 604 moves the pack panel 602 between a receiving position (e.g., a position for receiving refuse in the storage volume 500, etc.) and a packing position or an ejecting position.

According to the exemplary embodiments shown in FIGS. 13-15, the packer system 600 includes a ramped or curved wall 610 and a pivot plate 612. A first end 614 of the pivot plate 612 is rotatably coupled to a distal end of the pack panel 602 so that the pivot plate 612 rotates relative to the pack panel 602 as the pack panel 602 moves between retracted and extended positions. A second end 616 of the pivot plate 612 is configured to engage and slide along the curved wall 610 (e.g., when the pack panel 602 is in a position where the second end 616 of the pivot plate 612 overlaps with the curved wall 610). The curved wall 610 defines a generally curved profile that ramps downwardly in a direction toward the storage volume 500.

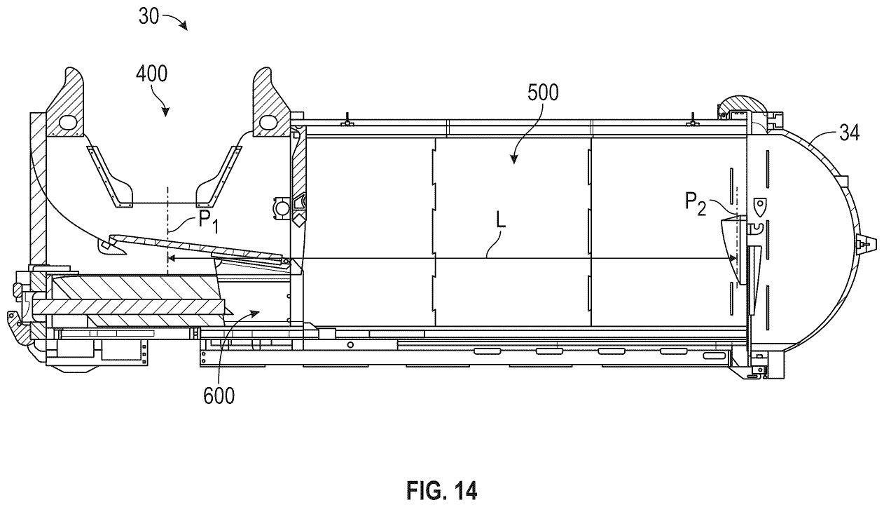

A packing procedure generally includes moving the pack panel 602 from the retracted position (see, e.g., FIG. 13) to a position where the pack panel 602 is at least partially extended from the retracted position in a direction toward the extended position (see, e.g., FIG. 14). According to the exemplary embodiment shown in FIG. 13, in the retracted position, the pack panel 602 is arranged at least partially within the hopper volume 400, and the packing procedure extends the pack panel 602 toward the storage volume 500 to compact and displace refuse in the hopper volume 400 in a direction toward the storage volume 500. This enables the hopper volume 400 to be repeatedly filled and packed until the storage volume 500 is full and an ejection procedure is required. According to the exemplary embodiments shown in FIGS. 10-12, in a retracted position, the pack panel 602 is positioned proximate a forward end of the storage volume 500 (e.g., a first end of the storage volume 500 positioned towards the direction of travel of the refuse vehicle 10, etc.), and the packing procedure extends the pack panel 602 toward a rearward end of the storage volume 500 (e.g., a second end of the storage volume 500 positioned away from the direction of travel of the refuse vehicle 10, etc.) to compact the refuse in the storage volume 500.

The ejection procedure generally includes moving the pack panel 602, via the packing actuator 604, to the extended or eject position (see, e.g., FIG. 15). During the ejection procedure, the tailgate 34 is opened and the pack panel 602 is moved to the extended position and refuse in the storage volume 500 is ejected. The movement of the pack panel 602 between the retracted position and the extended position defines a travel length or distance of the pack panel 602. According to the exemplary embodiment shown in FIGS. 13-15, in the retracted position, the pack panel 602 defines an initial plane P₁ and, in the extended position, the pack panel 602 defines a final plane P₂. A length L is defined between the initial plane P₁ and the final plane P₂ and represents the travel distance traversed by the pack panel 602 between the retracted and extended positions. In some embodiments, a forwardmost point of the pack panel 602 defines the initial plane P₁ in vertical direction perpendicular to the direction of travel of the refuse vehicle 10 (e.g., when the pack panel 602 does not extend generally vertically, etc.)

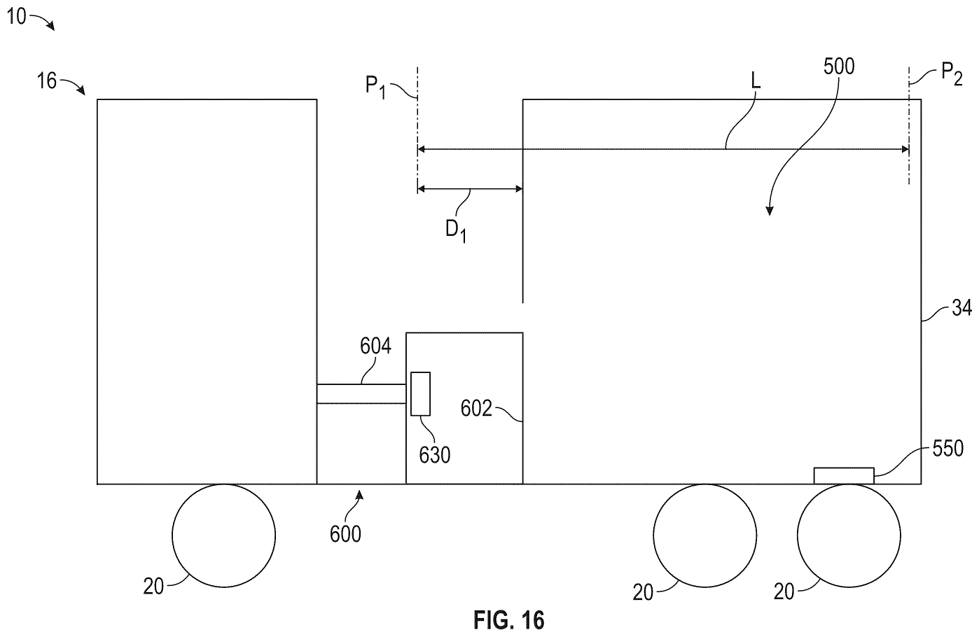

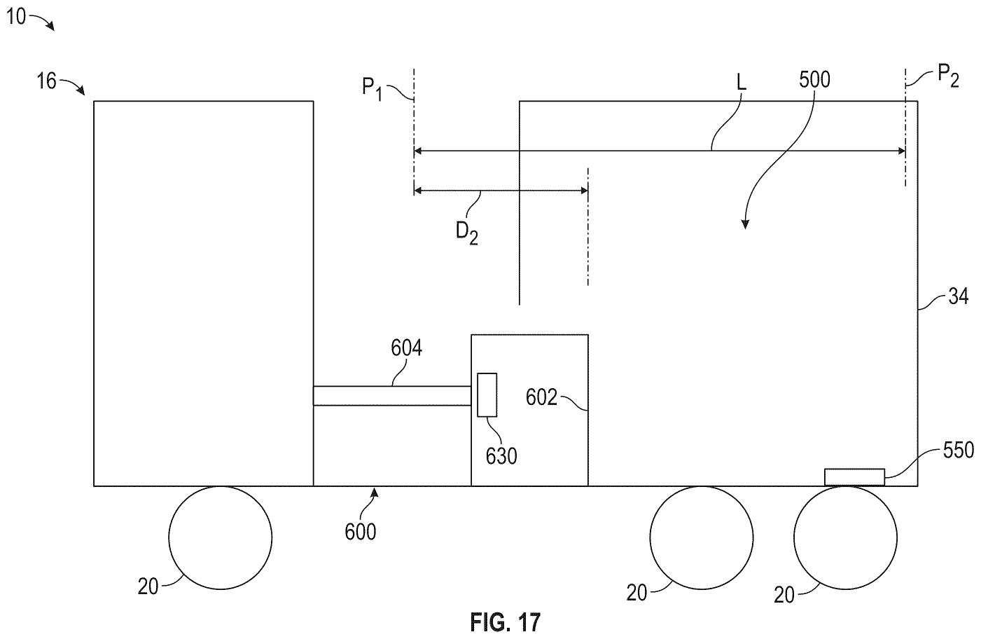

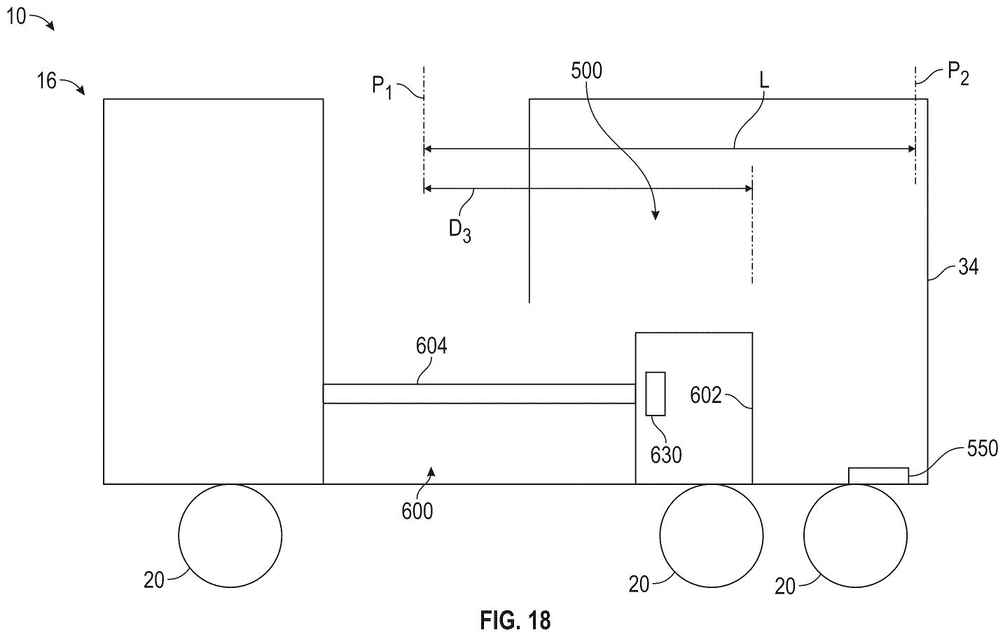

As described herein, the packing procedure generally includes moving the pack panel 602 from the retracted position to a position where the pack panel 602 is at least partially extended from the retracted position in a direction toward the extended position. The packing actuator 604 is configured to move the pack panel 602 to any position along the length L between the retracted position and the extended position. For example, turning to FIGS. 16-18, the packing actuator 604 is configured to move the pack panel 602 to a first position (FIG. 16), a second position (FIG. 17), or a third position (FIG. 18) along the length L. The second position is between the first position and the third position, and the first position is closer to the retracted position than the third position. In the first position, the pack panel 602 moves a first distance D₁ from the retracted position. The first distance D₁ is defined between the initial plane P₁ and the position of the pack panel 602 in the first position. In the second position the pack panel 602 moves a second distance D₂ from the retracted position. The second distance D₂ is defined between the initial plane P₁ and the position of the pack panel 602 in the second position. In the third position, the pack panel 602 moves a third distance D₃ from the retracted position. The third distance D₃ is defined between the initial plane P₁ and the position of the pack panel 602 in the third position. The first distance D₁ is less than the second distance D₂, and the second distance D₂ is less than the third distance D₃. In some embodiments, the first distance D₁ is between about 0% and about 35% of the length L, the second distance D₂ is between about 35% and 65% of the length L, and the third distance D₃ is between about 65% and about 100% of the length L.

During the packing procedure, the packing actuator 604 can extend the pack panel 602 to any one of the first position, the second position, the third position, or any other position between the retracted position and the extended position. According to the exemplary embodiment shown in FIG. 14, the packing actuator 604 extends the pack panel 602 to generally align with the holding plate 408 during the packing procedure. For example, a distance between the pack panel 602 and the initial plane P1 can be within about 2%, 5%, or 10% of a distance between the initial plane P1 and the pack panel 602 (e.g., a rear surface of the pack panel 602 that faces the storage volume 500). After the pack panel 602 extends away from the retracted position, the pack panel 602 returns to the retracted position to complete the packing procedure.

The packing actuator 604 is configured to pack the refuse in the storage volume 500 with different densities (e.g., apply different pressures on the refuse in the storage volume 500 through the pack panel 602, etc.). For example, the packing actuator 604 may apply a first pressure on the refuse in the storage volume 500 when the refuse is made up of organics and the packing actuator 604 may apply a second pressure on the refuse in the storage volume 500 when the refuse is made up of recyclables. In some embodiments, the packer system 600 may include one of the multiple sensors 126, shown as packing sensor 630. In some embodiments, the packing sensor 630 may be coupled to the pack panel 602 or the packing actuator 604 and be configured to detect a pressure applied on the refuse in the storage volume 500 by the pack panel 602. In various embodiments, the packing sensor 630 may be configured to detect a force applied on the refuse in the storage volume 500 by the pack panel 602, a distance that the pack panel 602 moves from the retracted position, etc. In some embodiments, the storage volume 500 may include one of the multiple sensors 126, shown as storage sensor 550. In some embodiments, the storage sensor 550 may be configured to detect a weight of the refuse in the storage volume 500, a fill level of the refuse in the storage volume 500, a pressure applied by the refuse contained in the storage volume 500 on the refuse compartment 30, etc.

### Object Recognition System

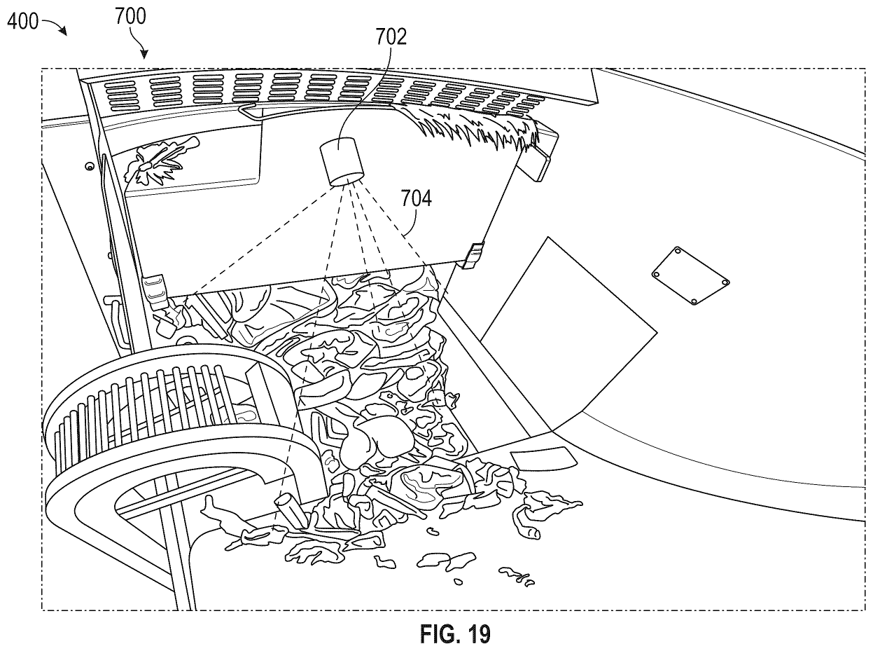

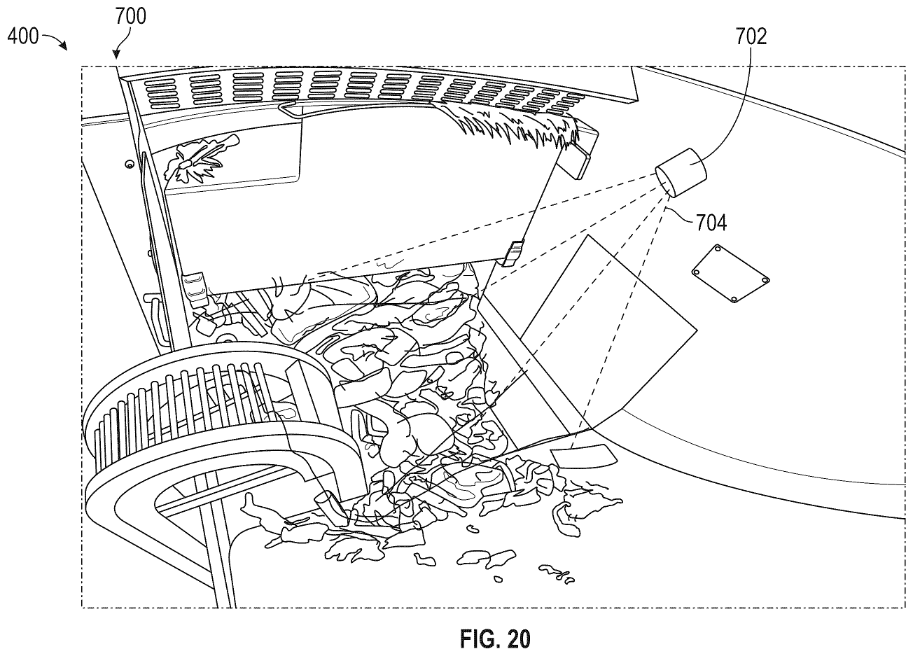

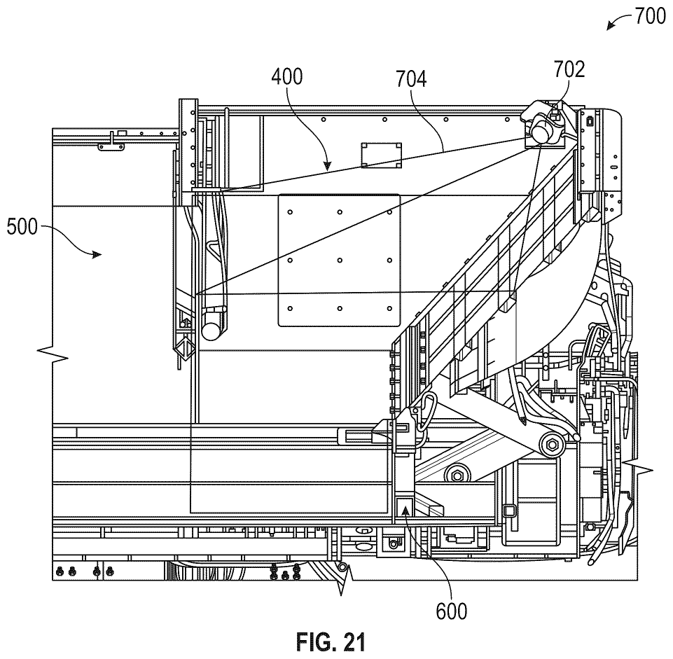

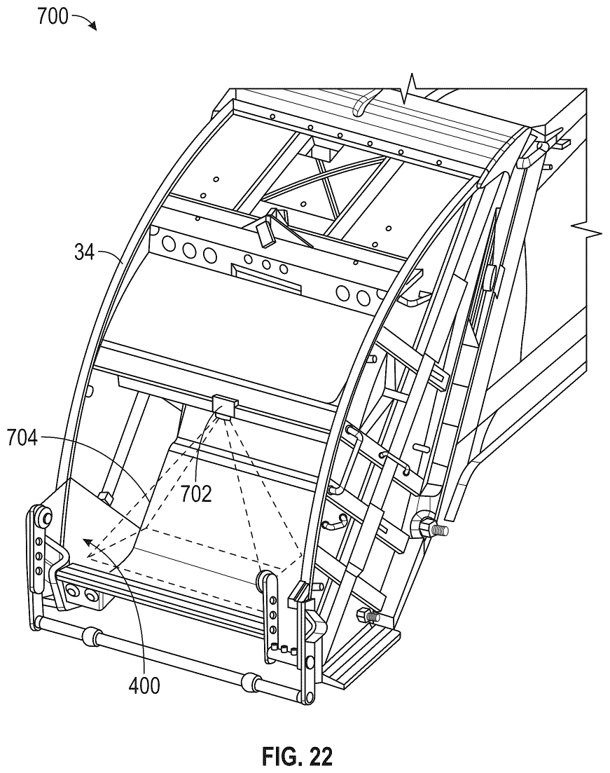

As shown in FIGS. 19-22, the vehicle 10 includes an object recognition system 700 (e.g., a refuse recognition system, a vision system, a refuse type system, etc.). The object recognition system 700 may be configured to detect different types of refuse received by the refuse vehicle 10. The object recognition system 700 may be configured to detect different types of refuse such as garbage, recycling, organics, etc. In some embodiments, the object recognition system 700 may be configured to detect different types of refuse containers such as garbage containers, recycling containers, residential containers, commercial containers, etc. The object recognition system 700 may use a variety of sensors, cameras, detectors, emitters, detection sub-systems, etc., to detect different types of refuse or different types of refuse containers. The object recognition system 700 may be similar to the system 600 for detecting a waste receptacle as described in greater detail in U.S. application Ser. No. 16/758,834, filed Apr. 23, 2020, the entire disclosure of which is incorporated by reference herein.

Still referring to FIGS. 19-22, the object recognition system 700 includes one or more cameras 702. The cameras 702 may be coupled to portions of the refuse compartment 30. The cameras 702 may be arranged so that a field of view 704 is directed toward the hopper volume 400, which enables the cameras 702 generate image data associated with objects positioned (e.g., disposed, located, etc.) within the hopper volume 400 (e.g., refuse positioned within the hopper volume 400, recyclables positioned within the hopper volume 400, etc.). In some embodiments, the cameras 702 are coupled to any internal surface or sidewall of the refuse compartment 30 so that the cameras 702 are arranged to direct the field of view 704 toward the hopper volume 400 and the refuse therein. The cameras 702 may alternatively or additionally be positioned on the lift arms 42 of the refuse vehicle 10, on tailgate 34 of the refuse vehicle 10, etc. so that the cameras 702 are arranged to direct the field of view 704 toward refuse containers that handled by the refuse vehicle 10 or positioned proximate the refuse vehicle 10. For example, the cameras 702 may be coupled to the lift arms 42 of the refuse vehicle 10 such that the field of view 704 is directed toward refuse containers that are engaged by the lift arms 42.

In use, the cameras 702 may capture real-time images inside of the hopper volume 400 as refuse is loaded into the hopper volume 400 (e.g., from the lift assembly 40, from the lift assembly 50, from the rear of the refuse vehicle 10, etc.). For example, the cameras 702 may capture real-time images as a refuse container is emptied into the hopper volume 400 (e.g., from a refuse container, etc.). The cameras 702 may alternatively or additionally capture real-time images of an area surrounding the refuse vehicle 10. For example, the cameras 702 may capture real-time images of a refuse container being engaged by the lift assembly 50, a refuse container being engaged by the lift assembly 40, a refuse container being emptied into the hopper volume 400, etc.

It should be understood that the positioning and arrangement of the cameras 702 as described herein with reference to FIGS. 19-22 is illustrative only and is not intended to be limiting. For example, any of the cameras 702 may be disposed on a top of the cab 16 such that cameras 702 are configured to determine the type of refuse in a refuse container positioned forward of the refuse vehicle 10.

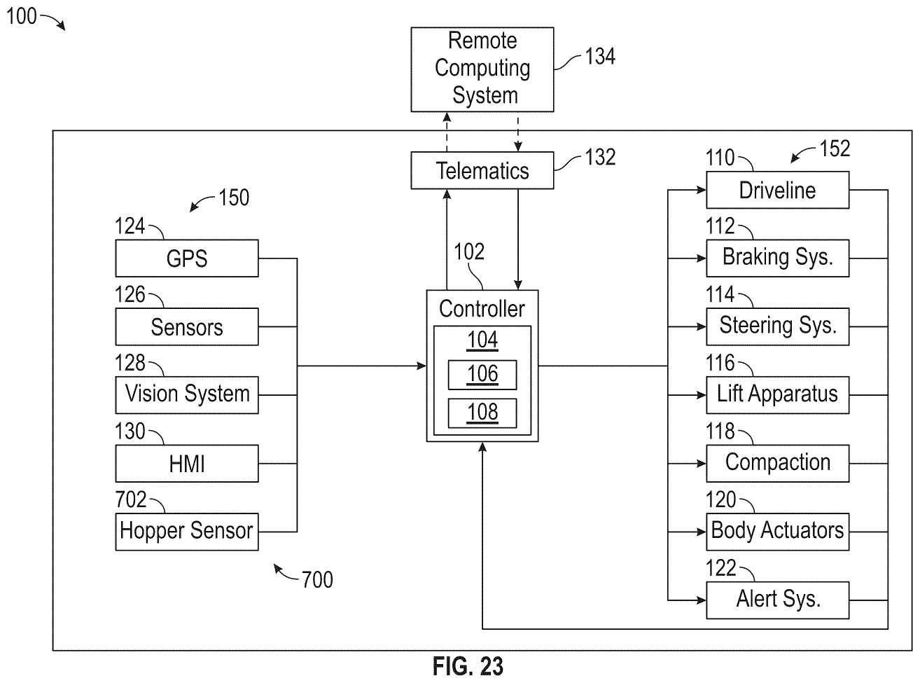

Referring to FIG. 23, the controller 102 is configured to obtain the image data from the cameras 702. For example, the cameras 702 may provide the image data to the controller 102. In some embodiments, the cameras 702 may provide the image data to the controller 102 in response to the cameras 702 detecting a change in the field of view 704 of the cameras 702. For example, the cameras 702 may provide the image data to the controller 102 in response to an object be placed within the field of view 704 of the cameras 702. In some embodiments, the controller 102 communicates with the remote computing system 134 via the telematics unit 132 to provide the image data received from the cameras 702. For example, the controller 102 may upload the image data received from the cameras 702 to the remote computing system 134 via the telematics unit 132 for further analysis. The controller 102 may receive instructions from the remote computing system 134 based on the image data provided to the remote computing system 134. For example, the controller 102 may receive a packing density parameter that corresponds to a type of refuse included in the image data provided to the telematics unit 132 by the controller 102. The controller 102 may utilize the instructions in order to operate the controllable elements 152 of the refuse vehicle 10. For example, the controller 102 may utilize the instructions in order to operate the compaction system 118 and/or the alert system 122.

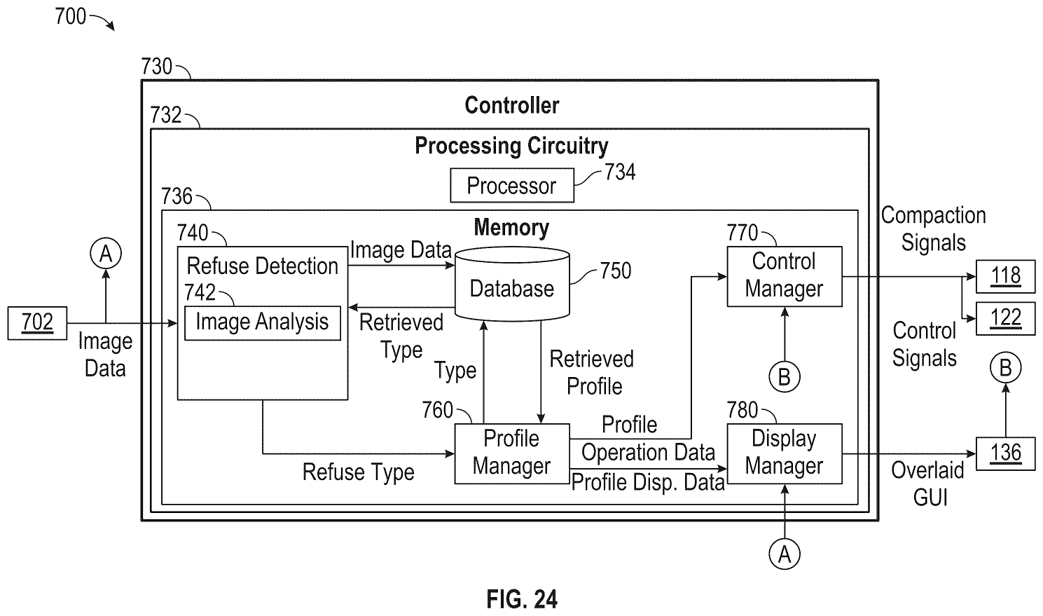

Referring to FIG. 24, the object recognition system 700 includes a controller 730 configured to receive the image data from the cameras 702. The controller 730 includes processing circuitry 732 including a processor 734 and memory 736. Processing circuitry 732 can be communicably connected with a communications interface of controller 730 such that processing circuitry 732 and the various components thereof can send and receive data via the communications interface. Processor 734 can be implemented as a general purpose processor, an application specific integrated circuit (ASIC), one or more field programmable gate arrays (FPGAs), a group of processing components, or other suitable electronic processing components.

Memory 736 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 736 can be or include volatile memory or non-volatile memory. Memory 736 can include database components, object code components, script components, or any other type of information structure for supporting the various activities and information structures described in the present application. According to some embodiments, memory 736 is communicably connected to processor 734 via processing circuitry 732 and includes computer code for executing (e.g., by at least one of processing circuitry 732 or processor 734) one or more processes described herein.

As shown in FIG. 24, the memory 736 includes a refuse detection manager 740 that is configured to receive the image data and determine parameters (e.g., a type of refuse, a type of refuse container, a tag, a material, an identification etc.) associated with the image data. For example, the refuse detection manager 740 may be configured to perform various analysis on the image data in order to determine the parameters associated with the image data. In some embodiments, the refuse detection manager 740 determines a plurality of parameters associated with the image data. For example, if the image data includes a first type of refuse and a second type of refuse, the refuse detection manager 740 may determine that a first parameter is associated with the image data based on the first type of refuse and that a second parameter is associated with the image data based on the second type of refuse.

As shown in FIG. 24, the refuse detection manager 740 is configured to implement an image analysis technique 742 to determine the parameters associated with the image data. The image analysis technique 742 can include implementing image recognition methodology (e.g., a neural network, machine learning, artificial intelligence, etc.) to determine the parameters associated with the image data received from the cameras 702. For example, the image analysis technique 742 can use image recognition methodology to identify an object included in the image data and determine the parameters associated with the image data based on the identification of the object. The image analysis technique 742 may include using a database, shown as database 750, that includes refuser image data associated with predetermined objects, predetermined labels, and/or predetermined parameters in order to determine the parameters associated with the image data. For example, the database 750 may include reference image data associated with trash bags, bottles, Styrofoam, industrial waste, cans, tree branches, grass clippings, recycling containers, residential containers, commercial containers, or any other types of refuse or refuse containers that may be encountered by the refuse vehicle 10. In some embodiments, the database 750 may include reference image data associated with animals, people (e.g., human bodies, etc.), hazardous waste, or other objects that could be incidentally encountered by the refuse vehicle 10.

The image analysis technique 742 may include using the reference image data to identify the parameters associated with the image data. For example, if the image data from the cameras 702 includes a trash bag, the image analysis technique 742 may include using the refuse database 750 to identify the trash bag and determine that the parameter associated with the image data is a garbage parameter by matching the image data with the reference image data associated with trash bags. As another example, if the image data from the cameras 702 includes a blue recycling container, the image analysis technique 742 may include using the database 750 to identify the blue recycling container and determine that the parameter associated with the image data is a recycling parameter by matching the image data with the reference image data associated with blue recycling containers. As yet another example, if the image data from the cameras 702 includes a commercial refuse container, the image analysis technique 742 may include using the refuse database 750 to identify the commercial refuse container and determine that the parameter associated with the image data is a commercial parameter by matching the image data with the reference image data associated with commercial containers.

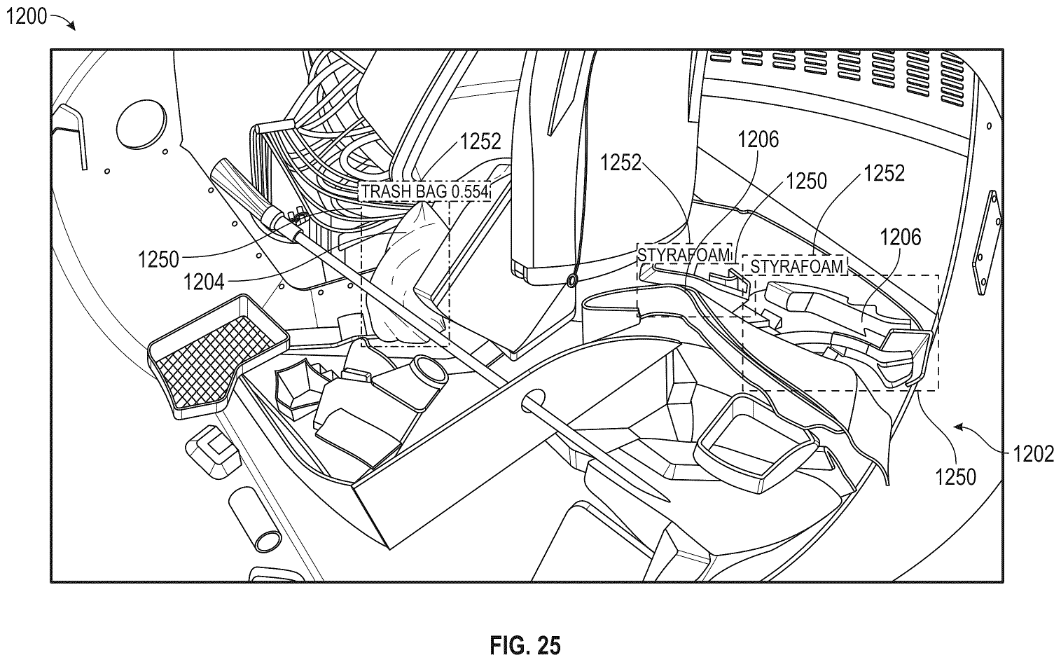

For example, as shown in FIG. 25, the refuse detection manager 740 may receive image data from the cameras 702 that includes a first image 1200 that depicts recycling 1202, a trash bag 1204, and Styrofoam 1206. The refuse detection manager 740 may implement the image analysis technique 742 to determine the parameters that correspond to the image data. For example, the refuse detection manager 740 may implement the image analysis technique 742 to compare the image data to the reference image data stored in the database 750 to determine that the first image 1200 depicts the recycling 1202, the trash bag 1204, and the Styrofoam 1206. As a result, the refuse detection manager 740 may determine that the parameters associated with the image data are a recycling parameter, a trash bag parameter, and a Styrofoam parameter. In some embodiments, the refuse detection manager 740 may determine portions of the first image 1200 that are associated with each of the parameters. For example, the refuse detection manager 740 may determine that a first portion of the first image 1200 that depicts the trash bag 1204 is associated with the trash bag parameter and that a second portion and a third portion of the first image 1200 that depict the Styrofoam 1206 are associated with the Styrofoam parameter.

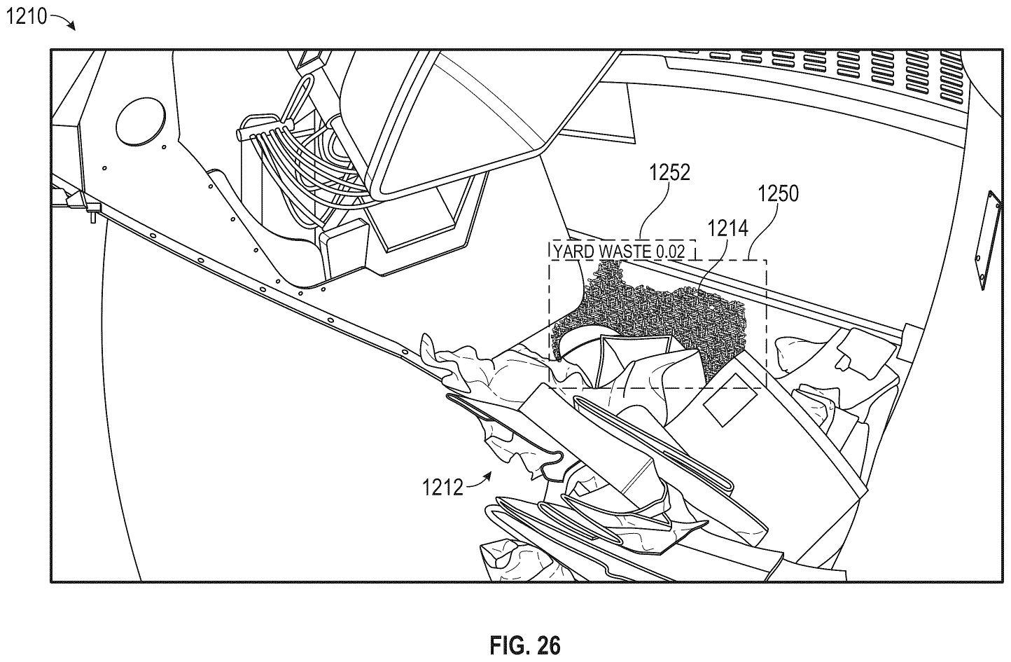

As another example, as shown in FIG. 26, the refuse detection manager 740 may receive image data from the cameras 702 that includes a second image 1210 that depicts recycling 1212 and yard waste 1214 The refuse detection manager 740 may implement the image analysis technique 742 to determine the parameters that correspond to the image data. For example, the refuse detection manager 740 may implement the image analysis technique 742 to compare the image data to the reference image data stored in the database 750 to determine that the second image 1210 depicts the recycling 1212 and the yard waste 1214. As a result, the refuse detection manager 740 may determine that the parameters associated with the image data are a recycling parameter and an organics parameter. In some embodiments, the refuse detection manager 740 may determine portions of the second image 1210 that are associated with each of the parameters. For example, the refuse detection manager 740 may determine that a portion of the second image 1210 that depicts the yard waste 1214 is associated with the organics parameter.

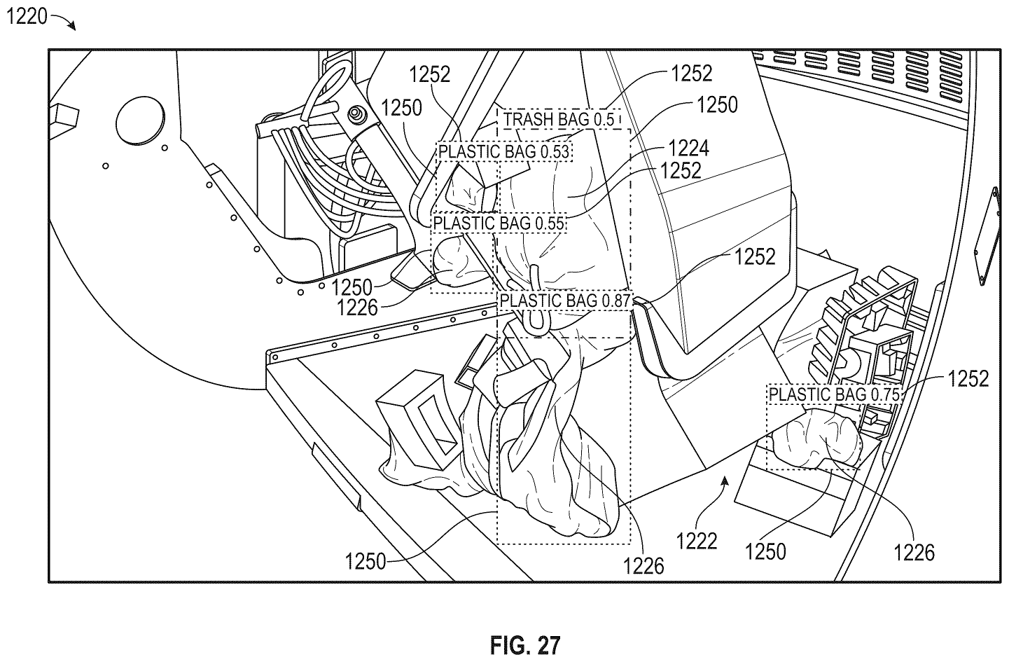

As another example, as shown in FIG. 27, the refuse detection manager 740 may receive image data from the cameras 702 that includes a third image 1220 that depicts recycling 1222, a trash bag 1224, and plastic bags 1226. The refuse detection manager 740 may implement the image analysis technique 742 to determine the parameters that correspond to the image data. For example, the refuse detection manager 740 may implement the image analysis technique 742 to compare the image data to the reference image data stored in the database 750 to determine that the third image 1220 depicts the recycling 1222, the trash bag 1224, and the plastic bags 1226. As a result, the refuse detection manager 740 may determine that the parameters associated with the image data are a recycling parameter, a trash bag parameter, and a plastic bag parameter. In some embodiments, the refuse detection manager 740 may determine portions of the third image 1220 that are associated with each of the parameters. For example, the refuse detection manager 740 may determine that a first portion of the third image 1220 that depicts the trash bag 1224 is associated with the trash bag parameter and that second portions of the first image 1200 that depict the plastic bags 1226 are associated with the plastic bag parameter.

As shown in FIG. 24, the refuse detection manager 740 is configured to provide the parameters associated with the image data to a profile manager 760. The profile manager 760 is configured to use the parameters in order to determine a packing profile (e.g., a compaction profile, a refuse type profile, etc.) for the refuse vehicle 10. The profile manager 760 may generate the packing profile based on the parameters associated with the image data. The profile manager 760 may identify, based on the parameters associated with the image data, one or more compaction settings for the compaction system 118. The compaction settings corresponding to the parameters associated with the image data can be included in the packing profile. The profile manager 760 may use a database, shown as the database 750, of predetermined profiles (e.g., a garbage profile, a recycling profile, an organics profile, a commercial profile, a residential profile, etc.) in order to determine the packing profile for the refuse vehicle 10. For example, if the parameter associated with the image data is an organics parameter, then the profile manager 760 may use the database 750 to determine that the packing profile for the objects is an organics packing profile. The organics packing profile may include an organic compaction setting for the compaction system 118 associated with organics. In some embodiments, the profile manager 760 determines the packing profile based on one of the parameters that is most relevant (e.g., higher score, etc.) to the image data. For example, if a majority of the objects included in the image data are garbage and a minority of the types of the objects are recyclable, a garbage parameter associated with the image data may be determined to be more relevant to the image data than a recyclable parameter associated with the image data. Based on the higher relevance of the garbage parameter over the recyclable parameter, the profile manager 760 may determine that the packing profile based on the garbage parameter instead of determining the packing profile based on the recyclable parameter. In other embodiments, the object recognition system 700 does not include the profile manager 760.

Referring still to FIG. 24, the memory 736 further includes a control manager 770 and a display manager 780. The control manager 770 is configured to receive the parameters associated with the image data from the refuse detection manager 740 and the packing profiles from the profile manager 760. The control manager 770 may generate control signals for the compaction system 118 based on the packing profiles and/or the parameters associated with the image data to operate the compaction system 118 based on the packing profiles and/or the parameters associated with the image data. The control manager 770 may generate the control signals in order to cause or allow operation of the compaction system 118 or to limit (e.g., prevent, restrict, lock, inhibit etc.), operation of the compaction system 118. The control manager 770 may generate the compaction signals based on the packing profile received from the profile manager 760 to cause the operation of the compaction system 118 to correspond with the packing profile. For example, if the control manager 770 receives a recycling packing profile from the profile manager 760, the control manager 770 may operate the compaction system 118 with the compaction settings corresponding to the recycling packing profile that sets an operating pressure that of compaction system 118 applies on the refuse in the storage volume 500 to a pressure that is optimal for recycling. As another example, the control manager 770 may generate control signals to limit operation of the compaction system 118 based a hazardous waste parameter being associated with the image data, which may indicate that hazardous waste is positioned within the hopper volume 400. As yet another example, when the refuse vehicle 10 is configured as a recycling vehicle, the control manager 770 may generate control signals to limit operation of the compaction system 118 based a trash parameter being associated with the image data, which may indicate that trash is positioned within the hopper volume 400 that could contaminate recyclables in the recycling vehicle. In some embodiments, the control manager 770 is configured to implement autonomous operation of the vehicle 10 based on the parameters associated with the image data and/or the packing profiles. For example, the control manager 770 may be configured to autonomously or semi-autonomously operate the compaction system 118 by providing the control signals to the compaction system 118 that are associated with the packing profiles.

The control manager 770 may generate alert signals for the alert system 122 based on the parameters associated with the image data and/or the packing profiles. The control manager 770 generate the alert signals and provide the alert signals to the alert system 122 in order to cause or allow the alert system 122 to provide an alert to individuals nearby the refuse vehicle 10 based on the parameters associated with the image data and/or the packing profiles. For example, the control manager 770 may generate an alert signal and provide the alert signal to the alert system 122 when the compaction setting of the compaction system 118 does not correspond with the packing profile determined by the profile manager 760. As another example, the control manager 770 may generate an alert signal and provide the alert signal to the alert system 122 when at least one of the parameters associated with the image data does not correspond with a configuration (e.g., a type, etc.) of the refuse vehicle 10 (e.g., a trash parameter when the refuse vehicle 10 is configured as a recycling vehicle, a recycling parameter when the refuse vehicle 10 is configured as a trash vehicle, a contaminant parameter when the refuse vehicle 10 is configured as a recycling vehicle, etc.).

In some embodiments, the control manager 770 may generate the alert signals for the alert system 122 when at least one of the parameters associated with the image data is a non-compliant parameter (e.g., a blacklisted parameter, an unwanted parameter, a non-compatible parameter, an undesired parameter, etc.). Non-compliant parameters may include hazardous parameters that are hazardous to the refuse vehicle 10 and/or the operator of the refuse vehicle 10, parameters that do not match an operating mode of the refuse vehicle 10 (e.g., trash or organics when the refuse vehicle 10 is operating in a recycling mode, recycling when the refuse vehicle 10 is operating in a trash mode, etc.), parameters associated with objects that should not be picked up by the refuse vehicle 10 (e.g., human beings, animals, etc.), etc. For example, the control manager 770 may generate an alert signal for the alert system 122 when the parameter is a human parameter associated with a human being or an animal parameter associated with an animal. As another example, the control manager 770 may generate an alert signal for the alert system 122 when the parameter is a hazardous parameter associated with hazardous materials. Advantageously, the control manager 770 may operate the alert system 122 to notify the operator of the refuse vehicle 10 when at least one of the parameters associated with the image data is the non-compliant parameter so that the operator can remove objects (e.g., remove from the hopper volume 400, remove from the refuse container 200, etc.) included in images of the image data before the objects are transferred into the storage volume 500. As a result, the refuse in the storage volume 500 may be prevented from being contaminated by non-compliant objects (e.g., trash, hazardous waste, etc.) and/or objects that are not intended to be transferred into the storage volume 500 can be prevented from being transferred into the storage volume 500 (e.g., humans, animals, etc.).

In some embodiments, the control manager 770 can cause the compaction system 118 to be operated in different preset operational modes based on the packing profile received from the profile manager 760 to more efficiently complete compaction of the refuse within the storage volume 500. For example, the same refuse vehicle 10 may be used to handle multiple of the refuse types (e.g., recycling, garbage, organics, commercial, residential, etc.) and the operational mode for the compaction system 118 changes depending on the refuse type that the refuse vehicle 10 is handling. The present operational modes may be selected to effectively deal with each of the types of refuse. For example, the rate at which the compaction system 118 operates can be included within performance parameters associated with the recycling operation mode. Recycling materials are generally lightweight and loosely packed (or entirely unpacked) materials and are advantageously compacted frequently to improve the overall capacity of the refuse compartment 30 of the refuse vehicle 10, so the rate at which the compaction system 118 operates (e.g., the rate at which the packer 46 compacts the refuse within the storage volume 500, the rate at which the tailgate compaction assembly 420 compacts the refuse from the hopper volume 400 to the storage volume 500, etc.) can be increased in the recycling operation mode.

The operation mode of the compaction system 118 set by the control manager 770 may affect pressure applied by the compaction system 118 on the refuse within the storage volume 500, the force applied by the compaction system 118 on the refuse within the storage volume 500, the distance traveled by the pack panel 602 into the storage volume 500, etc. In some embodiments, the control manager 770 can generate operational mode alert signals for the alert system 122 when the operational mode of the refuse vehicle 10 does not match the profile pack received from the profile manager 760. For example, if the refuse vehicle 10 is operating in a recycling operational mode and the profile manager 760 determines that the objects in the hopper volume 400 belong to a garbage packing profile, the control manager 770 may generate an operational mode alert signal to alert to individuals nearby the refuse vehicle 10 that the refuse vehicle 10 is not operating in correct operational mode.

The adjustability of the compaction system 118 may be similar to the adjustability of the weight distribution of the packed refuse as described in greater detail in U.S. application Ser. No. 10/943,182, filed Sep. 16, 2004, the entire disclosure of which is incorporated by reference herein. The execution of the operational modes may be similar to execution of the operational modes as described in greater detail in U.S. application Ser. No. 17/872,535, filed Jul. 25, 2022, the entire disclosure of which is incorporated by reference herein.

The display manager 780 is configured generate a graphical user interface (“GUI”) for an operator or user of the refuse vehicle 10 based on the results of the refuse detection manager 740. The display manager 780 may provide the GUI to the user interface 136 to be provided to an operator of the vehicle 10. The display manager 780 is configured to obtain the parameters associated with the image data from the refuse detection manager 740 and produce graphical displays corresponding to the parameters. For example, if the parameters associated with the image data include a trash parameter and a recycling parameter, the GUI may be generated to include a first element associated with the trash parameter and a second element associated with the recycling parameter.

In some embodiments, the display manager 780 is configured to generate the GUI based on the image data received from the cameras 702. For example, the GUI may include real time images included in the image data and the parameters associated with the image data. As shown in FIGS. 25-27, the GUI provided to the user interface 136 may include an image and various parameters overlaid (e.g., masked, etc.) over the portions of the image that are associated with each of the various parameters. The GUI provided to the user interface 136 may include target elements 1250 (e.g., indicating elements, first display elements, etc.) associated with areas of the image that depict refuse and parameter elements 1252 (e.g., second display elements, etc.) associated with parameters that correspond to the refuse depicted in the image. For example, as shown in FIG. 25, the GUI provided to the user interface 136 may include an image of refuse, a first target element 1250 associated with a first area of the image that depicts the trash bag 1204, a first parameter element 1252 proximate the first target element 1250 associated with a first parameter that corresponds to the trash bag 1204, a second target element 1250 associated with a second area of the image that depicts first Styrofoam, a second parameter element 1252 proximate the second target element 1250 associated with a second parameter that corresponds to the Styrofoam 1206, a third target element 1250 associated with a third area of the image that depicts second Styrofoam, and a third parameter element 1252 proximate the third target element 1250 associated with the second parameter that corresponds to the Styrofoam 1206. As another example, as shown in FIG. 26, the GUI provided to the user interface 136 may include an image of refuse, a target element 1250 associated with an area of the image that depicts yard waste 1214, and a parameter element 1252 proximate the target element 1250 associated with a parameter that corresponds to the yard waste 1214 (e.g., that lists the name of the parameter that corresponds to the yard waste 1214).

As yet another example, as shown in FIG. 27, the GUI provided to the user interface 136 may include an image of refuse, a first target element 1250 associated with a first area of the image that depicts a trash bag 1224, a first parameter element 1252 proximate the first target element 1250 associated with a first parameter that corresponds with the trash bag 1224, a second target element 1250 associated with a second area of the image that depicts a first plastic bag 1226, a second parameter element 1252 proximate the second target element 1250 associated with a second parameter that corresponds with the plastic bags 1226, a third target element 1250 associated with a third area of the image that depicts a second plastic bag 1226, a third parameter element 1252 proximate the third target element 1250 associated with the second parameter, a fourth target element 1250 associated with a fourth area of the image that depicts a third plastic bag 1226, a fourth parameter element 1252 proximate the fourth target element 1250 associated with the second parameter, a fifth target element 1250 associated with a fifth area of the image that depicts a fourth plastic bag 1226, and a fifth parameter element 1252 proximate the fifth targe element 1250 associated with the second parameter. As a result, the operator of the vehicle may use the GUI to identify objects included in the image data that are associated with each of the parameters. In some embodiments, the display manager 780 is configured to receive the packing profiles from the profile manager 760 and generate the GUI based on the packing profiles. For example, the GUI may include information associated with the packing profiles such as the operational mode of the compaction system 118 that is associated with the packing profile.

The user interface 136 may be positioned locally at the refuse vehicle 10 or may be at a remote location (e.g., at an operator or technician center for fleet management purposes). In some embodiments, the GUI generated by the display manager 780 may include elements (e.g., text, videos, images, buttons, etc.) indicating a recommended operational mode of the refuse vehicle 10. For example, if the profile manager 760 determines that the objects contained in the hopper volume 400 belong to a garbage profile pack, the display manager 780 may generate the GUI with an element recommending that the refuse vehicle 10 be placed in a corresponding garbage operational mode. In some embodiments, the elements included in the GUI may be actionable (e.g., part of a touch screen, a button, etc.) and a selection of one of the elements may place the refuse vehicle 10 into one of the operational modes corresponding to the one of the elements. For example, the GUI may include a touch screen and one of the elements included in the GUI may correspond with a commercial operational mode. When a user of the GUI selects the one of the elements, the refuse vehicle 10 may be placed in the commercial operational mode.

Referring still to FIG. 24, it should be understood that any of the functionality of the controller 730 may be implemented on the controller 102 of each of a fleet of refuse vehicles 10. In some embodiments, one or more functions of the controller 730 are implemented by the controller 102 and one or more functions of the controller 730 are implemented by the remote computing system 134 with which the controller 102 is in communication. In one example, the remote computing system 134 includes the database 750 and is configured to provide requested profiles to the controller 102 which implements the functionality of the refuse detection manager 740, the profile manager 760, the control manager 770, and the display manager 780. In another example, the remote computing system 134 is configured to implement all of the functionality of the controller 730 except the obtaining of the image data. The controller 102 may be responsible for obtaining, from the cameras 702, the image data, which are forwarded (e.g., via the telematics unit 132) to the remote computing system 134 which implements the functionality of the controller 730 as shown. The remote computing system 134 may provide the controller 102 with the compaction signals and the control signals such that the controller 102 can operate the compaction system 118 and the alert system 122. Accordingly, any of the functionality of the controller 730 may be performed in a distributed manner between the controller 102 and the remote computing system 134.

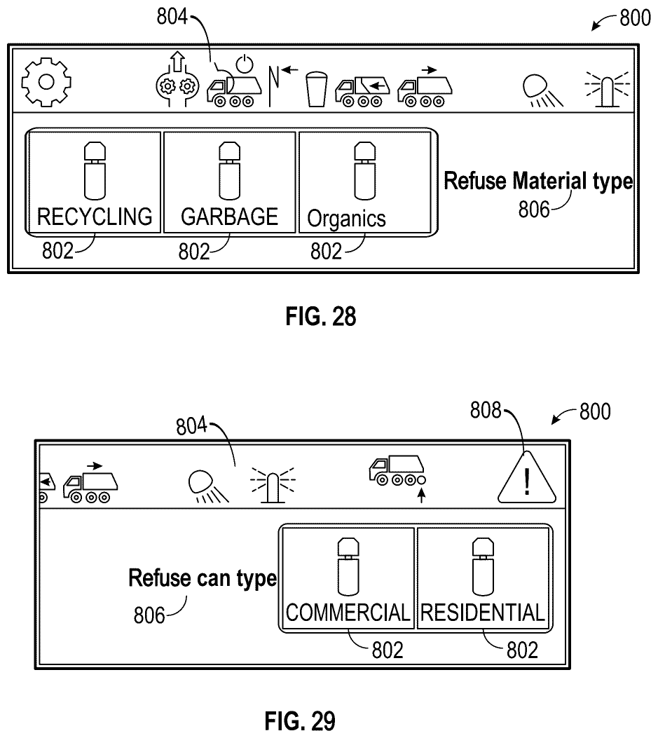

Referring to FIG. 28, an illustration of a configuration of a user interface 800 on the user interface 136 is shown. In some embodiments, the user interface 800 is generated and provided by the display manager 780 and provided to the user interface 136 to be displayed to a user.

As illustrated, the user interface 800 includes a plurality of operational mode indicators 802, a plurality of status indicators 804, and a mode type indicator 806. The operational mode indicators 802 displays content related to the operational modes of the refuse vehicle 10 so that the user may identify each of the operational modes. The content related to the operational modes may include descriptions of the operational modes, photographs corresponding to the operational modes, videos corresponding to the operational modes, or other elements that may relate to the operational modes. For example, the operational mode indicators 802 may display content relating to types of refuse such as a garbage operating mode, a recycling operating mode, an organics operating mode, or an operating mode relating to a different type of refuse. As another example, the operational mode indicators 802 may display content relating to types of refuse containers such as a residential operating mode, a commercial operating mode, or an operating mode relating to a different type of refuse container.

In some embodiments, the operational mode indicators 802 may include a variety of other text-based, color-based, or symbol-based indicators indicative of a status of the operational modes of the refuse vehicle 10. For example, the operational mode indicators 802 may include one or more of a color-coded indicator (e.g., a red indicator that the operational mode is not active, a yellow indicator that the operational mode is active but is not recommended, a green indicator that the operational mode is recommended, etc.), a predetermined shape-based symbol (e.g., a plus sign indicator that the operational mode is active and recommended, a minus sign indicator that the operational mode is active and is not recommended, etc.), or any other suitable type of operational mode indicators 802.

In some embodiments, one or more of the operational mode indicators 802 may be one or more actionable (e.g., interactable, etc.) buttons or items that influence the operational mode of the refuse vehicle 10. For example, the selection of one or the operational mode indicators 802 may place the refuses vehicle 10 in the operational mode that corresponds with the one of the operational mode indicators 802. For example, if a user selects the operational mode indicator 802 that corresponds with a recycling operational mode, the refuse vehicle 10 may be placed in the recycling operational mode.

The plurality of status indicators 804 displays content related to the operation of the refuse vehicle 10. For example, the status indicators 804 may include a fuel gage that indicates a quantity of fuel for the refuse vehicle 10 that remains in a fuel tank, a battery gage that indicates a quantity of electricity for the refuse vehicle 10 that remains in a battery, a storage volume indicator that indicates how much space is available within the storage volume 500, etc. The mode type indicator 806 displays descriptive text relating to the operational mode indicators 802. For example, the mode type indicator 806 may include descriptive text that details the type of operational modes that correspond with the operational mode indicators 802 included in the user interface 800 (e.g., “refuse material type” when the operational mode indicators 802 correspond with operational modes that relate to the type of refuse, etc.)

Referring to FIG. 29, an illustration of a configuration of a user interface 800 on the user interface 136 is shown. In some embodiments, the user interface 800 is generated and provided by the display manager 780 and provided to the user interface 136 to be displayed to a user.

As illustrated, the user interface 800 the operational mode indicators 802, the status indicators 804, the mode type indicator 806, and an operational mode alert indicator 808. The operational mode alert indicator 808 may display an alert when the operational mode of the refuse vehicle 10 does not correspond with the packing profile determined by the profile manager 760 based on the image data. For example, the operational mode alert indicator 808 may indicate that the refuse vehicle 10 is operating in a garbage operational mode, but that the profile manager 760 has determined that the packing profile of the refuse contained in the hopper volume 400 is a recycling packing profile. As another example, the operational mode alert indicator 808 may indicate that the refuse vehicle 10 is operating in a residential operational mode, but that the profile manager 760 has determined that the packing profile of a refuse container proximate the refuse vehicle 10 is a commercial packing profile.

### Communication System

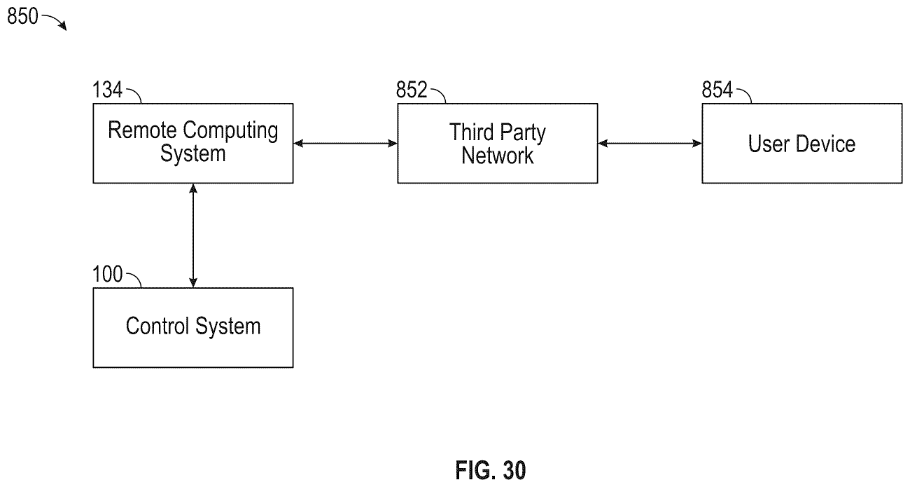

As shown in FIG. 30, a communication system 850 (e.g., fleet communication system, customer communication system, etc.) includes the control system 100 of the vehicle 10, the remote computing system 134, at least one third-party network 852, and at least one user device 854. FIG. 30 depicts an example of data transmission between the interconnected devices. For example, the control system 100 of the vehicle 10 may transmit data to the remote computing system 134 and the remote computing system 134 may transmit data to the user device 854 through the third-party network 852. In other embodiments, the control system 100 of the vehicle 10 transmits (e.g., directly transmits, etc.) data to the user device 854 through the third-party network 852. For example, the control system 100 may transmit data to the user device 854 through the third-party network 852 via the telematics unit 132. The user device 854 may be or include a cell phone, a smart phone, a tablet, a smart watch, a laptop, a desktop computer, a vehicle, and/or another other device that may be owned or operated by an operator of the refuse vehicle 10 (e.g., a driver of the refuse vehicle, a supervisor of the refuse vehicle 10, etc.) and/or a customer associated with the refuse picked up by the refuse vehicle 10 that is included in the image data. In some embodiments, the customer associated with the refuse picked up by the refuse vehicle 10 that is included in the image data may be determined by the remote computing system 134 based on a location of the refuse vehicle 10 and/or other information associated with the refuse vehicle 10 (e.g., a position along a route of the refuse vehicle, one of the parameters associated with the image data corresponding to the customer, etc.)

The remote computing system 134 may receive and/or determine the parameters associated with the image data generated by the cameras 702 of the object recognition system 700. For example, in some embodiments, the controller 102 of the control system 100 receives the image data from the cameras 702, determines the parameters associated with the image data (e.g., when the controller 102 is configured to perform the functionality of the refuse detection manager 740, etc.), and provides the parameters to the remote computing system 134 via the telematics unit 132. As another example, in some embodiments, the control system 100 receives the image data from the cameras 702, provides the image data to the remote computing system 134 via the telematics unit 132, and the remote computing system 134 determines the parameters associated with the image data based on the image data (e.g., when the remote computing system 134 is configured to perform the functionality of the refuse detection manager 740, etc.). In various embodiments, the remote computing system 134 receives the image data from the control system 100 of the vehicle 10 generated by the cameras 702.

The remote computing system 134 may provide the parameters associated with the image data to the user device 854 through the third-party network 852. In some embodiments, the third-party network 852 may be and/or include a local area network (LAN), wide area network (WAN), telephone network (such as the Public Switched Telephone Network (PSTN)), Controller Area Network (CAN), wireless link, intranet, the Internet, a cellular network and/or combinations thereof. In some embodiments, the third-party network 852 is a cellular network associated with one of the cellular service providers. For example, one of the third-party network 852 may provide the parameters associated with the image data to the user devices 854 associated with the third-party (e.g., user devices that receive service from the third party, etc.) over a cellular network of the third-party. In some embodiments, the remote computing system 134 provides the image data to the user device 854 through the third-party network third-party network 852. In other embodiments, the control system 100 provides the parameters associated with the image data and/or the image data to the user device 854 through the third-party network 852 (e.g., via the telematics unit 132, etc.).

In some embodiments, the remote computing system 134 provides the image data and/or the parameters associated with the image data acquired from the control systems 100 of multiple of the refuse vehicles 10 to the user device 854 through the third-party network 852. For example, the remote computing system 134 may provide the image data and/or the parameters associated with the image data of the multiple of the refuse vehicles 10 to the user device 854 of a fleet manager of the multiple of the refuse vehicles 10 such that the fleet manager may manage the multiple of the refuse vehicles 10.

In some embodiments, the remote computing system 134 and/or the control system 100 provides the image data and/or the parameters associated with the image data to the user device 854 through the third-party network 852 in response to at least one of the parameters being a non-compliant parameter. For example, in response to one of the parameters associated with the image data being a contaminant parameter associated with a contaminant, the remote computing system 134 may provide the contaminant parameter to the user device 854 through the third-party network 852. As another example, in response to one of the parameters associated with the image data being a hazardous parameter associated with a hazardous material, the remote computing system 134 may provide the image data to the user device 854 through the third-party network 852 such that a user of the user device 854 is provided with an image of the hazardous material. In some embodiments, the remote computing system 134 and/or the control system 100 provide the image data and/or the parameters associated with the image data to the user device 854 through the third-party network 852 in response to the refuse included in the image data being transferred from the hopper volume 400 to the storage volume 500.

In some embodiments, the user device 854 may generate an interface and/or an audible alert corresponding to the image data and/or the parameters associated with the image data received by the user device 854 and provide the interface to graphical user interfaces (GUI) of the user devices 854. For example, the interface may include images included in the image data and the parameters associated with the image data. For example, as shown in FIGS. 24-26, the interface provided to the GUI of the user device 854 may include an image and various parameters (e.g., display elements, parameters associated with objects within refuse, etc.) overlaid over the portions of the image that are associated with each of the various parameters. As a result, a customer associated with refuse included in the image data may be made aware of the parameters associated with the image data. For example, if a contaminant parameter is associated with the image data, the customer may be made aware that the refuse associated with the customer included a contaminant. As another example, if a hazardous parameter is associated with the image data, the customer may be made aware that the refuse associated with the customer included a hazardous material. Advantageously, providing the image data of refuse associated with a customer and/or the parameters associated with the image data to the customer may provide the customer with information associated with the refuse that was picked up from the customer. For example, the customer may be made aware that the refuse picked up from the customer included non-compliant objects to educate the customer to avoid including the non-compliant object in future refuse pickups. As another example, the customer may be made aware that the refuse was picked up from the customer.

### Process for Determining Pack Profile

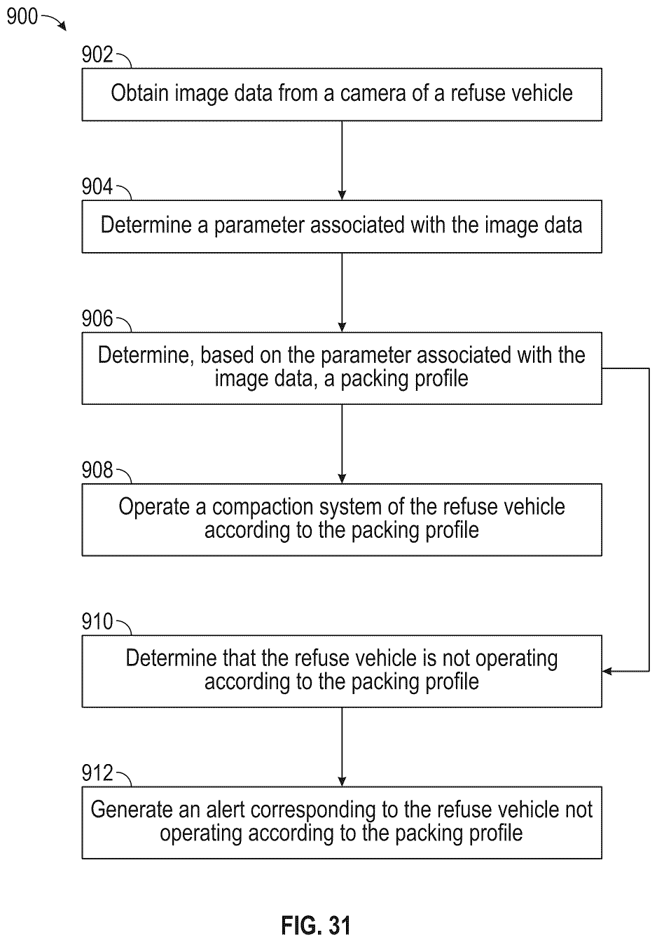

Referring to FIG. 31, a flow diagram of a process 900 for determining a pack profile for a compaction system of a refuse vehicle using image data includes steps 902-912, according to some embodiments. In some embodiments, the process 900 is performed by the controller 102 and/or the remote computing system 134 based on data obtained from one or more of the input devices 150 of the refuse vehicle 10. In some embodiments, the process 900 is performed by the controller 730 based on data obtained from the object recognition system 700 of the refuse vehicle 10. The process 900 may be implemented in order to operate the refuse vehicle 10 according to a packing profile associated with a type of refuse, or to alert an operator of the refuse vehicle 10 that the refuse vehicle 10 is not being operating according to the packing profile associated with the type of refuse.

The process 900 includes obtaining image data from a camera of a refuse vehicle (step 902), according to some embodiments. Step 902 can be performed by the controller 102 by obtaining image data from one or more of the input devices 150 or the cameras 702 of the object recognition system 700. The image data may include objects contained within the hopper volume 400 of the refuse compartment 30. For example, the image data received by the controller 102 may include images of refuse contained within the hopper volume 400. In some embodiments, the image data may include refuse containers that are being handled by the refuse vehicle 10 or that are positioned proximate the refuse vehicle 10. For example, the image data received by the controller 102 may include images of a refuse container being handled by the lift assembly 40 or positioned next to the refuse vehicle 10.

The process 900 includes determining a parameter associated with the image data (step 904), according to some embodiments. Step 904 can be performed by the controller 102 and/or the remote computing system 134 based on the image data received from the one or more of the input devices 150. In some embodiments, the image data may be received from the cameras 702 and the image data may include objects located within the fields of view 704 of the cameras 702. In some embodiments, the controller 102 may determine the parameter associated with the image data by implementing image recognition technology (e.g., a neural network, machine learning, artificial intelligence, etc.) to detect types of refuse associated with the objects. For example, the controller 102 may determine that a trash bag included in the image data may correspond with a garbage parameter. As another example, the controller 102 may determine that a commercial container included in the image data may correspond with a commercial parameter. In some embodiments, the parameter associated with the image data may be determined by the refuse detection manager 740 using the image analysis technique 742.

The process 900 includes determining a packing profile corresponding with the refuse type associated with the object (step 906), according to some embodiments. Step 906 can be performed by the controller 102 and/or the remote computing system 134 based on the parameter associated with the image data determined in step 904. In some embodiments, the packing profile may include predetermined operational parameters of the compaction system 118 of the refuse vehicle 10. For example, the packing profile may include a rate for operating the compaction system 118 based on the parameter associated with the image data, a pressure for operating the compaction system 118 based on the parameter associated with the image data, etc. In some embodiments, the packing profile may correspond with the parameter associated with a majority of the objects included the image data. For example, the image data may include objects contained within the hopper volume 400 of the refuse compartment 30 and step 904 may determine a first parameter based on a first set of the objects and a second parameter based on a second set of the objects. The packing profile may correspond with the parameter associated with the majority of the objects contained within the hopper volume 400.

The process 900 includes operating a compaction system of the refuse vehicle according to the packing profile (step 908), according to some embodiments. Step 908 can be performed by the controller 102 and/or the remote computing system 134 based on the packing profile determined in step 906. In some embodiments, the controller 102 may operate the compaction system 118 of the refuse vehicle 10 according to the predetermined operational parameters including in the packing profile. For example, the packing profile may include a rate for operating the compaction system 118 and the controller 102 may operating the compaction system 118 according to the rate. In some embodiments, the controller 102 may place the refuse vehicle 10 in an operational mode corresponding with the packing profile. The operational mode may include preselected operational parameters corresponding with different of the types of refuse. For example, the controller 102 may place the refuse vehicle 10 in a recycling operational mode to operate the refuse vehicle 10 according to a recycling packing profile.

The process 900 includes determining that the refuse vehicle is not operating according to the packing profile (step 910), according to some embodiments. Step 910 can be performed by the controller 102 and/or the remote computing system 134 based on the packing profile determined in step 906 and the operating parameters of the refuse vehicle 10. For example, the packing profile may include a first rate of operation for the compaction system 118 and the refuse vehicle 10 may be operating the compaction system 118 at a second rate. The controller 102 may determine that the refuse vehicle 10 is not operating with the second rate of operation that is including in the packing profile. In some embodiments, the controller 102 may determine that the refuse vehicle 10 is not placed in an operational mode included in the packing profile. For example, the packing profile may include a first operational mode associated with garbage and the refuse vehicle 10 may be placed in a second operational mode associated with recycling. The controller 102 may determine that the refuse vehicle 10 is not operating according to the packing profile since the refuse vehicle 10 is placed in the second operational mode instead of the first operational mode.

The process 900 includes generating an alert corresponding to the refuse vehicle not operating according to the packing profile (step 912), according to some embodiments. Step 910 can be performed by the controller 102 and/or the remote computing system 134 based on the determination that the refuse vehicle 10 is not operating according to the packing profile determined in step 910. The controller 102 may generate an alert for the alert system 122 to notify an operator of the refuse vehicle 10 that the refuse vehicle 10 is not operating according to the packing profile. In some embodiments, the controller 102 may operate the user interface 136 to display an alert to a user of the user interface 136 that the vehicle 10 is not operating according to the packing profile.

### Process for Identifying Non-Compliant Parameters

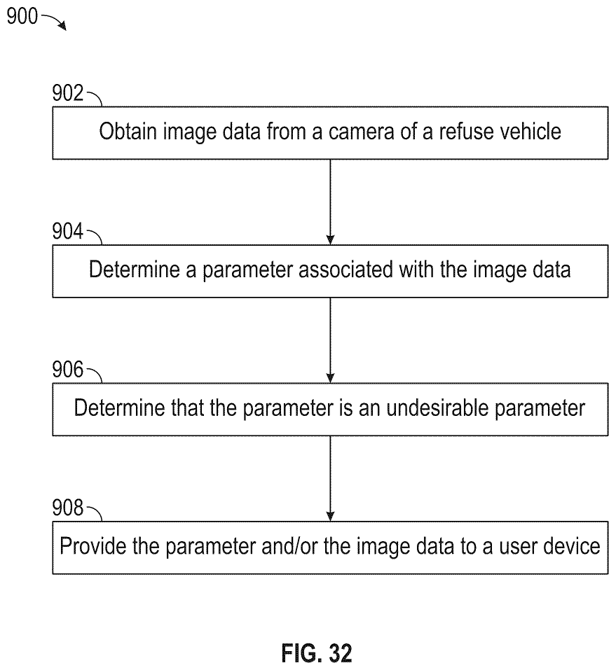

Referring to FIG. 32, a flow diagram of a process 1000 for identifying non-compliant parameters associated with image data from a camera of a refuse vehicle includes steps 1002-1008 according to some embodiments. In some embodiments, the process 1000 is performed by the controller 102 and/or the remote computing system 134 based on data obtained from one or more of the input devices 150 of the refuse vehicle 10. In some embodiments, the process 1000 is performed by the controller 730 based on image data obtained from cameras 702 of the refuse vehicle 10. The process 1000 may be implemented in order to notify customers associated with refuse picked up by the refuse vehicle 10 that the refuse included a non-compliant object.

The process 1000 includes obtaining image data from a camera of a refuse vehicle (step 1002), according to some embodiments. Step 1002 can be performed by the controller 102 by obtaining image data from one or more of the input devices 150 or the cameras 702 of the object recognition system 700. The image data may include objects contained within the hopper volume 400 of the refuse compartment 30. For example, the image data received by the controller 102 may include images of refuse contained within the hopper volume 400. In some embodiments, the image data may include refuse containers that are being handled by the refuse vehicle 10 or that are positioned proximate the refuse vehicle 10. For example, the image data received by the controller 102 may include images of a refuse container being handled by the lift assembly 40 or positioned next to the refuse vehicle 10.

The process 1000 includes determining a parameter associated with the image data (step 1004), according to some embodiments. Step 1004 can be performed by the controller 102 and/or the remote computing system 134 based on the image data received from the one or more of the input devices 150. In some embodiments, the image data may be received from the cameras 702 and the image data may include objects located within the fields of view 704 of the cameras 702. In some embodiments, the controller 102 may determine the parameter associated with the image data by implementing image recognition technology (e.g., a neural network, machine learning, artificial intelligence, etc.) to detect types of refuse associated with the objects. For example, the controller 102 may determine that a trash bag included in the image data may correspond with a garbage parameter. As another example, the controller 102 may determine that a commercial container included in the image data may correspond with a commercial parameter. In some embodiments, the parameter associated with the image data may be determined by the refuse detection manager 740 using the image analysis technique 742.

The process 1000 includes determining that the parameter is a non-compliant parameter (step 1006), according to some embodiments. Step 1006 can be performed by the controller 102 and/or the remote computing system 134 by comparing the parameter associated with the image data to predetermined non-compliant parameters to determine if the parameter associated with the image data is a non-compliant parameter. For example, the parameter may be a non-compliant parameter if the parameter is a hazardous parameter, a contaminant parameter, and/or a parameter associated with an object that does not belong in the storage volume 500 of the refuse vehicle 10.

The process 1000 includes providing the parameter and/or the image data to a user device (step 1008), according to some embodiments. Step 1008 can be performed by the controller 102 and/or the remote computing system 134 by providing the parameters and/or the image data to the user device 854 through the third-party network 852. In some embodiments, step 1008 includes providing the parameter and/or the image data to a customer associated with refuse included in the image data such that the customer is notified that the refuse is associated with the non-compliant parameter.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. A refuse vehicle comprising:
a chassis;
a body coupled to the chassis, the body defining a refuse compartment configured to receive refuse therein;
a camera oriented toward the refuse compartment; and
one or more processing circuits communicably coupled to the camera configured to:
acquire, from the camera, image data corresponding to refuse acquired by the refuse vehicle;
determine, based on the image data, at least one parameter corresponding to at least one object within the refuse;
generate, based on the image data and the at least one object within the refuse, display data including the image data and at least one display element identifying the at least one object within the refuse; and
provide the display data to a user interface of the refuse vehicle.

2. The refuse vehicle of claim 1, wherein the at least one display element identifies the at least one parameter corresponding to the at least one object within the refuse.

3. The refuse vehicle of claim 1, wherein:
the refuse compartment comprises:
a hopper volume configured to receive the refuse; and
a storage volume configured to receive the refuse from the hopper volume and store the refuse; and
the camera is oriented towards the hopper volume such that the image data is associated with the refuse positioned within the hopper volume.

4. The refuse vehicle of claim 1, wherein the at least one parameter includes a non-compliant parameter corresponding to a contaminant within the refuse received by the refuse compartment.

5. The refuse vehicle of claim 1, further comprising:
a compaction system configured to compact the refuse stored within the refuse compartment;
wherein the one or more processing circuits are further configured to:
determine, based on the at least one parameter, a packing profile for the compaction system, the packing profile including at least one packing parameter associated with operation of the compaction system; and
operate the compaction system according to the packing profile.

6. The refuse vehicle of claim 5, wherein:
the at least one parameter includes a first parameter associated with a first portion of the at least one object and a second parameter associated with a second portion of the at least one object, and
the one or more processing circuits are configured to determine that the packing profile is a first packing profile corresponding to the first parameter or a second packing profile corresponding to the second parameter by comparing a quantity of the at least one object in the first portion of the at least one object and the second portion of the at least one object.

7. The refuse vehicle of claim 1, further comprising:
a compaction system configured to compact the refuse stored within the refuse compartment;
wherein the one or more processing circuits are further configured to:
inhibit, based on the image data depicting the at least one object, operation of the compaction system;
acquire, from the camera, updated image data corresponding to the refuse acquired by the refuse vehicle; and
responsive to the updated image data depicting that the at least one object was removed from the refuse compartment, operate the compaction system to compact the refuse within the refuse compartment.

8. A method of operating a refuse vehicle, the method comprising:
acquiring, from a camera onboard a refuse vehicle, image data corresponding to refuse acquired by the refuse vehicle;
determining, based on the image data, at least one parameter corresponding to at least one object within the refuse;
generating, based on the image data and the at least one parameter, display data including the image data and at least one display element identifying the at least one object within the refuse; and
providing the display data to a user interface of the refuse vehicle.

9. The method of claim 8, wherein the at least one display element identifies the at least one parameter corresponding to the at least one object within the refuse.

10. The method of claim 8, wherein the at least one display element identifies a location of each of the at least one object within an image of the image data.

11. The method of claim 8, wherein the at least one parameter includes a non-compliant parameter corresponding to a contaminant within the refuse received by the refuse vehicle.

12. The method of claim 8, further comprising:
determining, based on the at least one parameter, a packing profile for a compaction system of the refuse vehicle, the packing profile including at least one packing parameter associated with operation of the compaction system; and
operating the compaction system according to the packing profile.

13. The method of claim 12, wherein:
the at least one parameter includes a first parameter associated with a first portion of the at least one object and a second parameter associated with a second portion of the at least one object, and
determining the packing profile include determining that the packing profile is a first packing profile corresponding to the first parameter or a second packing profile corresponding to the second parameter by comparing a quantity of the at least one object in the first portion of the at least one object and the second portion of the at least one object.

14. The method of claim 8, further comprising:
inhibiting, based on the image data depicting the at least one object, operation of a compaction system of the refuse vehicle;
acquiring, from the camera, updated image data corresponding to the refuse acquired by the refuse vehicle; and
responsive to the updated image data depicting that the at least one object was removed from a refuse compartment of the refuse vehicle, operating the compaction system to compact the refuse within the refuse compartment.

15. A control system for a refuse vehicle comprising:
a camera; and
one or more processing circuits configured to be communicably coupled to the camera, the one or more processing circuits configured to:
acquire, from the camera, image data corresponding to refuse acquired by the refuse vehicle;
determine, based on the image data, at least one parameter corresponding to at least one object within the refuse, wherein the at least one parameter includes a non-compliant parameter corresponding to a contaminant within the refuse;
generate, based on the image data and the at least one parameter, display data including the image data and at least one display element identifying the at least one object within the refuse; and
provide the display data to a user interface of the refuse vehicle.

16. The control system of claim 15, wherein the one or more processing circuits include:
a first portion configured to be positioned on the refuse vehicle, the first portion configured to at least generate the display data and provide the display data to the user interface; and
a second portion configured to be remote from the refuse vehicle, the second portion configured to at least determine the at least one parameter corresponding to the at least one object within the refuse.

17. The control system of claim 15, wherein the one or more processing circuits are further configured to:
determine, based on the at least one parameter, a packing profile for a compaction system of the refuse vehicle, the packing profile including at least one packing parameter associated with operation of the compaction system; and
operate the compaction system according to the packing profile.

18. The control system of claim 17, wherein:
the at least one parameter includes a first parameter associated with a first portion of the at least one object and a second parameter associated with a second portion of the at least one object, and
the one or more processing circuits are configured to determine that the packing profile is a first packing profile corresponding to the first parameter or a second packing profile corresponding to the second parameter by comparing a quantity of the at least one object in the first portion of the at least one object and the second portion of the at least one object.

19. The control system of claim 15, wherein the one or more processing circuits are further configured to:
inhibit, based on the image data depicting the at least one object, operation of a compaction system of the refuse vehicle;
acquire, from the camera, updated image data corresponding to the refuse acquired by the refuse vehicle; and
responsive to the updated image data depicting that the at least one object was removed from a refuse compartment of the refuse vehicle, operate the compaction system to compact the refuse within the refuse compartment.

20. The control system of claim 15, wherein the at least one display element identifies the at least one parameter corresponding to the at least one object within the refuse.
